(19) United States
(12) Patent Application Publication
(10) Pub. No.: US 2026/0324645 A1
(43) Pub. Date: Oct. 22, 2026

(54) AGRICULTURE COMPOSITIONS, AND METHODS OF USE

(71) Applicant: REMOTE EPIGENETICS INC., ENCINITAS, CA (US)

(72) Inventors: PAUL ZORNER, ENCINITAS, CA (US); JOVANNI NUNEZ, ENCINITAS, CA (US)

(21) Appl. No.: 19/644,683

(22) Filed: Apr. 10, 2026

Related U.S. Application Data
(60) Provisional application No. 63/787,325, filed on Apr. 11, 2025.

(51) Int. Cl. A01N 57/20; A01N 31/02; A01N 37/02; A01N 37/10; A01N 43/16; A01P 13/00

(52) U.S. Cl. CPC A01N 57/20; A01N 31/02; A01N 37/02; A01N 37/10; A01N 43/16; A01P 13/00

(57) ABSTRACT

The subject invention provides improved herbicide compositions and methods of using these compositions.

### CROSS-REFERENCE TO A RELATED APPLICATION

This application claims priority to U.S. Provisional Patent Application No. 63/787,325, filed Apr. 11, 2025, which is incorporated herein by reference in its entirety.

### BACKGROUND OF THE INVENTION

The protection of crop plants (crops) from weed plants (weeds) and other unwanted vegetation which inhibit crop growth is a constantly recurring problem in agriculture. To help combat this problem, researchers in the field of synthetic chemistry have produced an extensive variety of active herbicidal ingredients (herbicides) and formulations effective in the control of such unwanted growth. Herbicides of many structural types and with different modes of action have been disclosed in the literature and a large number are in commercial use.

Active herbicidal ingredients (herbicides) are typically categorized according to their Mode of Action (MoA) (or Site of Action (SoA)). The Mode of Action of herbicides is inter alia relevant concerning the weed spectrum that herbicides are able to control and in particular with respect to the ability to control unwanted plants (weeds) which are resistant (tolerant) or are evolving resistance (tolerance) to one or more Modes of Action.

In normal use, the different classes of herbicides have proved to be very effective across a range of weeds. However, an increasing problem encountered in agriculture is the appearance of weeds that have developed a tolerance to classes of herbicides with certain Modes of Action. By ‘tolerance’ or ‘resistance’ is meant that these weeds are less easily damaged or killed by the application of these herbicides than the normal phenotype. Typically, these weeds show little or no damage when these herbicides are applied at normal application rates. This tolerance arises naturally and occurs because of the selection pressure exerted on the weed population by repeated application of these herbicides. Some weeds have developed almost complete tolerance to herbicides of a certain Mode of Action, that is, they are virtually undamaged by these herbicides at the normal commercial application rates. Sometimes the word ‘resistant’ is also used to describe such weeds, in particular where they have the inherited ability to survive treatment by these herbicides.

Herbicide resistant weeds present a serious problem for efficient weed control because such resistant weeds are increasingly widespread and, thus, weed control by the application of herbicides is no longer effective.

Thus, there is a need for effective and efficient compositions and methods for the control of herbicide resistant weeds.

### BRIEF SUMMARY OF THE INVENTION

The subject invention provides improved herbicide compositions and methods of using these compositions.

In specific embodiments, the subject invention provides adjuvants for use in herbicide compositions. Advantageously, when used with an adjuvant of the subject invention, plants that are resistant to a particular herbicide can be controlled by the combined use of that herbicide with the adjuvant of the subject invention. Thus, the adjuvants of the subject invention can be used to overcome herbicide resistance.

In further embodiments of the subject invention, advantageous adjuvants described herein can be used to increase the effectiveness of herbicides so that less herbicide is needed to control weeds and other unwanted vegetation.

In specific embodiments, the adjuvants of the subject invention can be used to improve the efficacy of herbicides including, but not limited to, glyphosate, Atrazine, 2,4-D (2,4-Dichlorophenoxyacetic acid), Dicamba, Glufosinate-Ammonium, Paraquat, sethoxydim, ALS inhibitors, MCPA, flutenacet, ACCase inhibitors, Metolachlor, Imazapyr, Pendimethalin, Trifluralin and pelargonic acid, so that they are effective at lower concentrations and/or on herbicide resistant plants.

In certain specific embodiments, the adjuvants are applied with pelargonic acid, and/or one or more other fatty acids or derivatives thereof having herbicidal properties such as, e.g., capric acid, caprylic acid, oleic acid and/or linoleic acid. The adjuvant can be applied with the fatty acid as a pre-mixed formulation and/or as a tank mixture combining the ingredients separately.

Weeds that can be controlled according to the subject invention include, but are not limited to, Amaranthus palmeri (Palmer amaranth) and foxtail species (e.g., Setaria viridis and Setaria pumila).

Furthermore, it has been found that compositions and methods according to the subject invention are also suitable for the defoliation and/or desiccation of plant parts, for which crop plants such as cotton, potato, oilseed rape, sunflower, soybean, field beans, wheat, oats and other small grains, in particular small grains and cotton, are suitable. In this regard compositions of the subject invention can be used for the desiccation and/or defoliation of plants.

Thus, in certain embodiments, an adjuvant of the subject invention can be used in combination with a herbicide for pre-harvest grain desiccation. Advantageously, when used in conjunction with an adjuvant of the subject invention, the amount of herbicide used for pre-harvest desiccation can be reduced, thereby reducing the amount of herbicide residue in the processed grain. In one embodiment, the herbicide is glyphosate.

In a further embodiment, the compositions and methods of the subject invention can be used for the termination of cover crops. Cover crops (non-crop plants used to improve, for example, soil fertility and stability) are often difficult to terminate prior to planting the primary crop, especially if they have resistant weeds growing with them. The compositions and methods of the subject invention can be used to terminate the cover crop as well as resistant weeds.

### BRIEF DESCRIPTION OF THE DRAWINGS

FIG. 1 shows a representative photo of four weed plant seeds that have germinated and have been treated according to the subject invention.

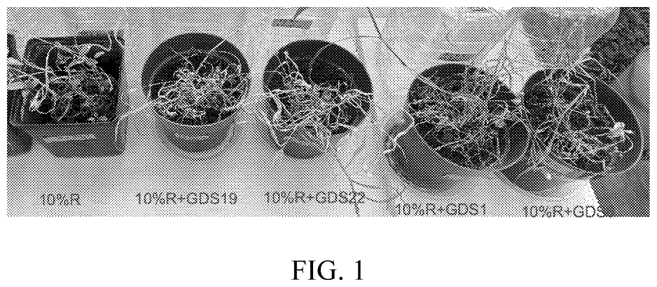

### DETAILED DESCRIPTION OF THE INVENTION

The subject invention provides improved herbicide and other agriculture compositions and methods of using these compositions.

In specific embodiments, the subject invention provides materials and methods for enhancing the efficacy of an active agricultural ingredient in comparison to the active agricultural ingredient when used alone, wherein an adjuvant of the subject invention is administered to a plant and/or the plant's surrounding environment either before, simultaneously with, or after the active agricultural ingredient. Thus, the subject invention provides methods for delivering an active agricultural chemical to plants and/or their surrounding environment to provide a benefit to the plant and/or environment, wherein the benefit is enhanced due to the use of the adjuvant composition.

According to the subject methods, the adjuvant and the active agricultural ingredient can be mixed together prior to administration to produce an agricultural composition as, for example, a sprayable tank mix. In some embodiments, the two components are applied individually but in such a way as to produce the agricultural composition at the point of administration. In such embodiments, the methods comprise applying the two components within, for example, 24 hours, preferably within 12 hours, more preferably within 60 minutes before or after one another.

In other embodiments, the adjuvant can be incorporated into the herbicide formulation (e.g., a pre-mix) as a component of a single commercial formulation.

The subject methods can improve efficacy of the active agricultural chemical by at least 1%, 5%, 10%, 15%, 20%, 25%, 30%, 40%, or at least 50% compared with methods in which the chemical is applied without the adjuvant. Improved efficacy can include, for example, reduced dosage, greater pest control, overcoming resistance of weeds to the herbicide being applied, increased plant yields, reduced water usage, and other quantitative or qualitative measures of efficacy.

In certain embodiments, the subject methods also comprise performing one or more measurements to assess the effect of the methods of the subject invention on the enhancing of the described agriculture activity.

Measurements can be conducted at a certain time point after application thereof to the site. In some embodiments, the measurements are conducted after about 1 week or less, 2 weeks or less, 3 weeks or less, 4 weeks or less, 30 days or less, 60 days or less, 90 days or less, 120 days or less, 180 days or less, and/or 1 year or less.

Furthermore, the measurements can be repeated over time. In some embodiments, the measurements are repeated daily, weekly, monthly, bi-monthly, semi-monthly, semi-annually, and/or annually.

The methods and compositions of the subject invention can be used either alone or in combination with other compounds for, e.g., efficiently enhancing soil and/or plant health. For example, in some embodiments, the method comprises applying additional components, including additional herbicides, fertilizers, pesticides, soil amendments, irrigation additives and/or plant growth regulators to the soil and/or plants. The exact materials and the quantities thereof can be determined by, for example, a grower or soil scientist having the benefit of the subject disclosure.

In specific embodiments, the subject invention provides adjuvants for use in herbicide compositions. Advantageously, when used with an adjuvant of the subject invention, plants that are resistant to a particular herbicide can be controlled. Thus, the adjuvants of the subject invention can be used to overcome herbicide resistance.

In specific embodiments, the adjuvants of the subject invention can be used to improve the efficacy of herbicides including, but not limited to, glyphosate, Atrazine, 2,4-D (2,4-Dichlorophenoxyacetic acid), Dicamba, Glufosinate-Ammonium, Paraquat, sethoxydim, ALS inhibitors, MCPA, flutenacet, ACCase inhibitors, Metolachlor, Imazapyr, Pendimethalin, Trifluralin, and pelargonic acid so that they are effective at lower concentrations and/or on herbicide resistant plants. Examples of herbicide resistant plants are provided in Table 1.

TABLE 1
Herbicide Resistant Plants

| | | Common | | First | |
|---|---|---|---|---|---|
| # | Species | Name | Country | Year | Site of Action |
| 1 | Lolium perenne | Perennial | Argentina | 2008 | Inhibition of Enolpyruvyl |
| | | Ryegrass | | | Shikimate Phosphate |
| | | | | | Synthase HRAC Group 9 |
| | | | | | (Legacy G) |
| 2 | Avena fatua | Wild Oat | Argentina | 2010 | Inhibition of Acetyl CoA |
| | | | | | Carboxylase HRAC Group |
| | | | | | 1 (Legacy A) |
| 3 | Lolium rigidum | Rigid Ryegrass | Australia | 1985 | Multiple Resistance: 3 |
| | | | (New South Wales ) | | Sites of Action |
| | | | | | Inhibition of Acetyl CoA |
| | | | | | Carboxylase HRAC Group |
| | | | | | 1 (Legacy A) |
| | | | | | Inhibition of Acetolactate |
| | | | | | Synthase HRAC Group 2 |
| | | | | | (Legacy B) |
| | | | | | Inhibition of Microtubule |
| | | | | | Assembly HRAC Group 3 |
| | | | | | (Legacy K1) |
| 4 | Avena fatua | Wild Oat | Australia (New South | 1991 | Inhibition of Acetyl CoA |
| | | | Wales ) | | Carboxylase HRAC Group |
| | | | | | 1 (Legacy A) |
| 5 | Sisymbrium | Oriental Mustard | Australia (New South | 1994 | Inhibition of Acetolactate |
| | orientale | | Wales ) | | Synthase HRAC Group 2 |
| | | | | | (Legacy B) |
| 6 | Avena fatua | Wild Oat | Australia (New South | 2006 | Multiple Resistance: 3 |
| | | | Wales ) | | Sites of Action |
| | | | | | Inhibition of Acetyl CoA |
| | | | | | Carboxylase HRAC Group |
| | | | | | 1 (Legacy A) |
| | | | | | Inhibition of Acetolactate |
| | | | | | Synthase HRAC Group 2 |
| | | | | | (Legacy B) |
| | | | | | Antimicrotubule mitotic |
| | | | | | disrupter HRAC Group 25 |
| | | | | | (Legacy Z) |
| 7 | Phalaris | Hood | Australia (New South | 2012 | Multiple Resistance: 2 |
| | paradoxa | Canary grass | Wales ) | | Sites of Action |
| | | | | | Inhibition of Acetyl CoA |
| | | | | | Carboxylase HRAC Group |
| | | | | | 1 (Legacy A) |
| | | | | | Inhibition of Acetolactate |
| | | | | | Synthase HRAC Group 2 |
| | | | | | (Legacy B) |
| 8 | Raphanus | Wild Radish | Australia (New South | 2013 | Auxin Mimics HRAC |
| | raphanistrum | | Wales ) | | Group 4 (Legacy O) |
| 9 | Rapistrum | Turnipweed | Australia (New South | 2021 | Inhibition of Acetolactate |
| | rugosum | | Wales ) | | Synthase HRAC Group 2 |
| | | | | | (Legacy B) |
| 10 | Avena sterilis ssp. | Sterile oat | Australia (Queensland) | 2006 | Inhibition of Acetyl CoA |
| | ludoviciana | | | | Carboxylase HRAC Group |
| | | | | | 1 (Legacy A) |
| 11 | Lolium rigidum | Rigid Ryegrass | Australia (South | 1982 | Multiple Resistance: 6 |
| | | | Australia) | | Sites of Action |
| | | | | | Inhibition of Acetyl CoA |
| | | | | | Carboxylase HRAC Group |
| | | | | | 1 (Legacy A) |
| | | | | | Inhibition of Acetolactate |
| | | | | | Synthase HRAC Group 2 |
| | | | | | (Legacy B) |
| | | | | | Inhibition of Deoxy-D- |
| | | | | | Xylulose Phosphate |
| | | | | | Synthase HRAC Group 13 |
| | | | | | (Legacy F4) |
| | | | | | Inhibition of Microtubule |
| | | | | | Assembly HRAC Group 3 |
| | | | | | (Legacy K1) |
| | | | | | Inhibition of Microtubule |
| | | | | | Organization HRAC Group |
| | | | | | 23 (Legacy K2) |
| | | | | | Very Long-Chain Fatty |
| | | | | | Acid Synthesis inhibitors |
| | | | | | HRAC Group 15 (Legacy |
| | | | | | K3 N) |
| 12 | Sisymbrium | Oriental Mustard | Australia (South | 1990 | Inhibition of Acetolactate |
| | orientale | | Australia) | | Synthase HRAC Group 2 |
| | | | | | (Legacy B) |
| 13 | Lactuca serriola | Prickly Lettuce | Australia (South | 1994 | Inhibition of Acetolactate |
| | | | Australia) | | Synthase HRAC Group 2 |
| | | | | | (Legacy B) |
| 14 | Raphanus | Wild Radish | Australia (South | 1998 | Inhibition of Acetolactate |
| | raphanistrum | | Australia) | | Synthase HRAC Group 2 |
| | | | | | (Legacy B) |
| 15 | Galium | Threehorn | Australia (South | 2012 | Inhibition of Acetolactate |
| | tricornutum | Bedstraw | Australia) | | Synthase HRAC Group 2 |
| | | | | | (Legacy B) |
| 16 | Lolium rigidum | Rigid Ryegrass | Australia (Victoria) | 1984 | Multiple Resistance: 3 |
| | | | | | Sites of Action |
| | | | | | Inhibition of Acetyl CoA |
| | | | | | Carboxylase HRAC Group |
| | | | | | 1 (Legacy A) |
| | | | | | Inhibition of Acetolactate |
| | | | | | Synthase HRAC Group 2 |
| | | | | | (Legacy B) |
| | | | | | Inhibition of Microtubule |
| | | | | | Assembly HRAC Group 3 |
| | | | | | (Legacy K1) |
| 17 | Lactuca serriola | Prickly Lettuce | Australia (Victoria) | 2009 | Inhibition of Acetolactate |
| | | | | | Synthase HRAC Group 2 |
| | | | | | (Legacy B) |
| 18 | Raphanus | Wild Radish | Australia (Victoria) | 2009 | Multiple Resistance: 2 |
| | raphanistrum | | | | Sites of Action |
| | | | | | Inhibition of Acetolactate |
| | | | | | Synthase HRAC Group 2 |
| | | | | | (Legacy B) |
| | | | | | Auxin Mimics HRAC |
| | | | | | Group 4 (Legacy O) |
| 19 | Sisymbrium | Oriental Mustard | Australia (Victoria) | 2010 | Inhibition of Acetolactate |
| | orientale | | | | Synthase HRAC Group 2 |
| | | | | | (Legacy B) |
| 20 | Sonchus oleraceus | Annual | Australia (Victoria) | 2010 | Inhibition of Acetolactate |
| | | Sowthistle | | | Synthase HRAC Group 2 |
| | | | | | (Legacy B) |
| 21 | Raphanus | Wild Radish | Australia (Victoria) | 2011 | Auxin Mimics HRAC |
| | raphanistrum | | | | Group 4 (Legacy O) |
| 22 | Lolium rigidum | Rigid Ryegrass | Australia (Western | 1982 | Multiple Resistance: 3 |
| | | | Australia) | | Sites of Action |
| | | | | | Inhibition of Acetyl CoA |
| | | | | | Carboxylase HRAC Group |
| | | | | | 1 (Legacy A) |
| | | | | | Inhibition of Acetolactate |
| | | | | | Synthase HRAC Group 2 |
| | | | | | (Legacy B) |
| | | | | | Inhibition of Microtubule |
| | | | | | Assembly HRAC Group 3 |
| | | | | | (Legacy K1) |
| 23 | Lolium rigidum | Rigid Ryegrass | Australia (Western | 1984 | Inhibition of Acetolactate |
| | | | Australia) | | Synthase HRAC Group 2 |
| | | | | | (Legacy B) |
| 24 | Sisymbrium | Oriental Mustard | Australia (Western | 1994 | Inhibition of Acetolactate |
| | orientale | | Australia) | | Synthase HRAC Group 2 |
| | | | | | (Legacy B) |
| 25 | Raphanus | Wild Radish | Brazil | 2013 | Inhibition of Acetolactate |
| | raphanistrum | | | | Synthase HRAC Group 2 |
| | | | | | (Legacy B) |
| 26 | Kochia scoparia | Kochia | Canada (Alberta) | 1989 | Inhibition of Acetolactate |
| | | | | | Synthase HRAC Group 2 |
| | | | | | (Legacy B) |
| 27 | Avena fatua | Wild Oat | Canada (Alberta) | 1989 | Multiple Resistance: 2 |
| | | | | | Sites of Action |
| | | | | | Very Long-Chain Fatty |
| | | | | | Acid Synthesis inhibitors |
| | | | | | HRAC Group 15 (Legacy |
| | | | | | K3 N) |
| | | | | | Cell elongation inhibitors |
| | | | | | HRAC Group 8 (Legacy Z) |
| 28 | Setaria viridis | Green Foxtail | Canada (Alberta) | 1989 | Inhibition of Microtubule |
| | | | | | Assembly HRAC Group 3 |
| | | | | | (Legacy K1) |
| 29 | Sinapis arvensis | Wild Mustard | Canada (Alberta) | 1993 | Inhibition of Acetolactate |
| | | | | | Synthase HRAC Group 2 |
| | | | | | (Legacy B) |
| 30 | Sonchus asper | Spiny Sowthistle | Canada (Alberta) | 1996 | Inhibition of Acetolactate |
| | | | | | Synthase HRAC Group 2 |
| | | | | | (Legacy B) |
| 31 | Galeopsis tetrahit | Common | Canada (Alberta) | 1998 | Auxin Mimics HRAC |
| | | Hempnettle | | | Group 4 (Legacy O) |
| 32 | Thlaspi arvense | Field Pennycress | Canada (Alberta) | 2001 | Inhibition of Acetolactate |
| | | | | | Synthase HRAC Group 2 |
| | | | | | (Legacy B) |
| 33 | Salsola tragus | Russian-thistle | Canada (Alberta) | 2007 | Inhibition of Acetolactate |
| | | | | | Synthase HRAC Group 2 |
| | | | | | (Legacy B) |
| 34 | Lolium persicum | Persian Darnel | Canada (Alberta) | 2009 | Inhibition of Acetyl CoA |
| | | | | | Carboxylase HRAC Group |
| | | | | | 1 (Legacy A) |
| 35 | Kochia scoparia | Kochia | Canada (Alberta) | 2012 | Multiple Resistance: 2 |
| | | | | | Sites of Action |
| | | | | | Inhibition of Acetolactate |
| | | | | | Synthase HRAC Group 2 |
| | | | | | (Legacy B) |
| | | | | | Inhibition of Enolpyruvyl |
| | | | | | Shikimate Phosphate |
| | | | | | Synthase HRAC Group 9 |
| | | | | | (Legacy G) |
| 36 | Setaria viridis | Green Foxtail | Canada (Manitoba) | 1988 | Inhibition of Microtubule |
| | | | | | Assembly HRAC Group 3 |
| | | | | | (Legacy K1) |
| 37 | Kochia scoparia | Kochia | Canada (Manitoba) | 1988 | Inhibition of Acetolactate |
| | | | | | Synthase HRAC Group 2 |
| | | | | | (Legacy B) |
| 38 | Avena fatua | Wild Oat | Canada (Manitoba) | 1990 | Inhibition of Acetyl CoA |
| | | | | | Carboxylase HRAC Group |
| | | | | | 1 (Legacy A) |
| 39 | Sinapis arvensis | Wild Mustard | Canada (Manitoba) | 1990 | Auxin Mimics HRAC |
| | | | | | Group 4 (Legacy O) |
| 40 | Setaria viridis | Green Foxtail | Canada (Manitoba) | 1991 | Inhibition of Acetyl CoA |
| | | | | | Carboxylase HRAC Group |
| | | | | | 1 (Legacy A) |
| 41 | Sinapis arvensis | Wild Mustard | Canada (Manitoba) | 1992 | Inhibition of Acetolactate |
| | | | | | Synthase HRAC Group 2 |
| | | | | | (Legacy B) |
| 42 | Setaria viridis | Green Foxtail | Canada (Manitoba) | 1992 | Multiple Resistance: 2 |
| | | | | | Sites of Action |
| | | | | | Inhibition of Acetyl CoA |
| | | | | | Carboxylase HRAC Group |
| | | | | | 1 (Legacy A) |
| | | | | | Inhibition of Microtubule |
| | | | | | Assembly HRAC Group 3 |
| | | | | | (Legacy K1) |
| 43 | Avena fatua | Wild Oat | Canada (Manitoba) | 1994 | Multiple Resistance: 3 |
| | | | | | Sites of Action |
| | | | | | Inhibition of Acetyl CoA |
| | | | | | Carboxylase HRAC Group |
| | | | | | 1 (Legacy A) |
| | | | | | Inhibition of Acetolactate |
| | | | | | Synthase HRAC Group 2 |
| | | | | | (Legacy B) |
| | | | | | Antimicrotubule mitotic |
| | | | | | disrupter HRAC Group 25 |
| | | | | | (Legacy Z) |
| 44 | Avena fatua | Wild Oat | Canada (Saskatchewan) | 1990 | Inhibition of Acetyl CoA |
| | | | | | Carboxylase HRAC Group |
| | | | | | 1 (Legacy A) |
| 45 | Setaria viridis | Green Foxtail | Canada (Saskatchewan) | 1991 | Inhibition of Microtubule |
| | | | | | Assembly HRAC Group 3 |
| | | | | | (Legacy K1) |
| 46 | Setaria viridis | Green Foxtail | Canada (Saskatchewan) | 1996 | Inhibition of Acetyl CoA |
| | | | | | Carboxylase HRAC Group |
| | | | | | 1 (Legacy A) |
| 47 | Setaria viridis | Green Foxtail | Canada (Saskatchewan) | 1996 | Multiple Resistance: 2 |
| | | | | | Sites of Action |
| | | | | | Inhibition of Acetyl CoA |
| | | | | | Carboxylase HRAC Group |
| | | | | | 1 (Legacy A) |
| | | | | | Inhibition of Microtubule |
| | | | | | Assembly HRAC Group 3 |
| | | | | | (Legacy K1) |
| 48 | Avena fatua | Wild Oat | Canada (Saskatchewan) | 1996 | Multiple Resistance: 3 |
| | | | | | Sites of Action |
| | | | | | Inhibition of Acetyl CoA |
| | | | | | Carboxylase HRAC Group |
| | | | | | 1 (Legacy A) |
| | | | | | Inhibition of Acetolactate |
| | | | | | Synthase HRAC Group 2 |
| | | | | | (Legacy B) |
| | | | | | Very Long-Chain Fatty |
| | | | | | Acid Synthesis inhibitors |
| | | | | | HRAC Group 15 (Legacy |
| | | | | | K3 N) |
| 49 | Lolium persicum | Persian Darnel | Canada (Saskatchewan) | 2004 | Inhibition of Acetyl CoA |
| | | | | | Carboxylase HRAC Group |
| | | | | | 1 (Legacy A) |
| 50 | Stellaria media | Common | Canada (Saskatchewan) | 2005 | Inhibition of Acetolactate |
| | | Chickweed | | | Synthase HRAC Group 2 |
| | | | | | (Legacy B) |
| 51 | Galium spurium | False Cleavers | Canada (Saskatchewan) | 2006 | Inhibition of Acetolactate |
| | | | | | Synthase HRAC Group 2 |
| | | | | | (Legacy B) |
| 52 | Chenopodium | Common | Canada (Saskatchewan) | 2009 | Inhibition of Acetolactate |
| | album | Lambsquarters | | | Synthase HRAC Group 2 |
| | | | | | (Legacy B) |
| 53 | Kochia scoparia | Kochia | Canada (Saskatchewan) | 2012 | Multiple Resistance: 2 |
| | | | | | Sites of Action |
| | | | | | Inhibition of Acetolactate |
| | | | | | Synthase HRAC Group 2 |
| | | | | | (Legacy B) |
| | | | | | Inhibition of Enolpyruvyl |
| | | | | | Shikimate Phosphate |
| | | | | | Synthase HRAC Group 9 |
| | | | | | (Legacy G) |
| 54 | Lolium perenne | Italian Ryegrass | Chile | 2007 | Multiple Resistance: 3 |
| | ssp. multiflorum | | | | Sites of Action |
| | | | | | Inhibition of Acetyl CoA |
| | | | | | Carboxylase HRAC Group |
| | | | | | 1 (Legacy A) |
| | | | | | Inhibition of Acetolactate |
| | | | | | Synthase HRAC Group 2 |
| | | | | | (Legacy B) |
| | | | | | Inhibition of Enolpyruvyl |
| | | | | | Shikimate Phosphate |
| | | | | | Synthase HRAC Group 9 |
| | | | | | (Legacy G) |
| 55 | Avena sterilis | Sterile Oat | Cyprus | 2010 | Inhibition of Acetyl CoA |
| | | | | | Carboxylase HRAC Group |
| | | | | | 1 (Legacy A) |
| 56 | Stellaria media | Common | Denmark | 1991 | Inhibition of Acetolactate |
| | | Chickweed | | | Synthase HRAC Group 2 |
| | | | | | (Legacy B) |
| 57 | Tripleurospermum | Scentless | Denmark | 2010 | Inhibition of Acetolactate |
| | perforatum (= T. | Chamomile | | | Synthase HRAC Group 2 |
| | inodorum) | | | | (Legacy B) |
| 58 | Capsella bursa- | Shepherd's-purse | Denmark | 2012 | Inhibition of Acetolactate |
| | pastoris | | | | Synthase HRAC Group 2 |
| | | | | | (Legacy B) |
| 59 | Stellaria media | Common | Estonia | 2021 | Inhibition of Acetolactate |
| | | Chickweed | | | Synthase HRAC Group 2 |
| | | | | | (Legacy B) |
| 60 | Stellaria media | Common | Finland | 2013 | Inhibition of Acetolactate |
| | | Chickweed | | | Synthase HRAC Group 2 |
| | | | | | (Legacy B) |
| 61 | Apera spica-venti | Silky Windgrass | Germany | 2009 | Multiple Resistance: 3 |
| | | | | | Sites of Action |
| | | | | | Inhibition of Acetyl CoA |
| | | | | | Carboxylase HRAC Group |
| | | | | | 1 (Legacy A) |
| | | | | | Inhibition of Acetolactate |
| | | | | | Synthase HRAC Group 2 |
| | | | | | (Legacy B) |
| | | | | | PSII inhibitors - Serine 264 |
| | | | | | Binders HRAC Group 5 |
| | | | | | (Legacy C1 C2) |
| 62 | Stellaria media | Common | Germany | 2011 | Inhibition of Acetolactate |
| | | Chickweed | | | Synthase HRAC Group 2 |
| | | | | | (Legacy B) |
| 63 | Avena fatua | Wild Oat | Ireland | 2019 | Inhibition of Acetyl CoA |
| | | | | | Carboxylase HRAC Group |
| | | | | | 1 (Legacy A) |
| 64 | Alopecurus | Shortawn Foxtail | Japan | 2004 | Multiple Resistance: 2 |
| | aequalis | | | | Sites of Action |
| | | | | | Inhibition of Acetolactate |
| | | | | | Synthase HRAC Group 2 |
| | | | | | (Legacy B) |
| | | | | | Inhibition of Microtubule |
| | | | | | Assembly HRAC Group 3 |
| | | | | | (Legacy K1) |
| 65 | Beckmannia | American | Japan | 2010 | Inhibition of Microtubule |
| | syzigachne | Sloughgrass | | | Assembly HRAC Group 3 |
| | | | | | (Legacy K1) |
| 66 | Sonchus asper | Spiny Sowthistle | Norway | 2006 | Inhibition of Acetolactate |
| | | | | | Synthase HRAC Group 2 |
| | | | | | (Legacy B) |
| 67 | Polygonum | Ladysthumb | Norway | 2009 | Inhibition of Acetolactate |
| | persicaria | | | | Synthase HRAC Group 2 |
| | | | | | (Legacy B) |
| 68 | Avena fatua | Wild Oat | Poland | 2011 | Inhibition of Acetyl CoA |
| | | | | | Carboxylase HRAC Group |
| | | | | | 1 (Legacy A) |
| 69 | Avena fatua | Wild Oat | Poland | 2011 | Inhibition of Acetolactate |
| | | | | | Synthase HRAC Group 2 |
| | | | | | (Legacy B) |
| 70 | Avena fatua | Wild Oat | Poland | 2011 | Multiple Resistance: 2 |
| | | | | | Sites of Action |
| | | | | | Inhibition of Acetyl CoA |
| | | | | | Carboxylase HRAC Group |
| | | | | | 1 (Legacy A) |
| | | | | | Inhibition of Acetolactate |
| | | | | | Synthase HRAC Group 2 |
| | | | | | (Legacy B) |
| 71 | Raphanus | Wild Radish | South Africa | 1997 | Inhibition of Acetolactate |
| | raphanistrum | | | | Synthase HRAC Group 2 |
| | | | | | (Legacy B) |
| 72 | Stellaria media | Common | Sweden | 1995 | Inhibition of Acetolactate |
| | | Chickweed | | | Synthase HRAC Group 2 |
| | | | | | (Legacy B) |
| 73 | Avena fatua | Wild Oat | United | 1996 | Cell elongation inhibitors |
| | | | States (California) | | HRAC Group 8 (Legacy Z) |
| 74 | Avena fatua | Wild Oat | United | 1997 | Inhibition of Acetyl CoA |
| | | | States (Colorado) | | Carboxylase HRAC Group |
| | | | | | 1 (Legacy A) |
| 75 | Avena fatua | Wild Oat | United | 1990 | Multiple Resistance: 2 |
| | | | States (Montana) | | Sites of Action |
| | | | | | Very Long-Chain Fatty |
| | | | | | Acid Synthesis inhibitors |
| | | | | | HRAC Group 15 (Legacy |
| | | | | | K3 N) |
| | | | | | Cell elongation inhibitors |
| | | | | | HRAC Group 8 (Legacy Z) |
| 76 | Setaria viridis | Green Foxtail | United | 2005 | Inhibition of Acetyl CoA |
| | | | States (Montana) | | Carboxylase HRAC Group |
| | | | | | 1 (Legacy A) |
| 77 | Stellaria media | Common | United | 2010 | Inhibition of Acetolactate |
| | | Chickweed | States (Pennsylvania) | | Synthase HRAC Group 2 |
| | | | | | (Legacy B) |
| 78 | Anthemis cotula | Mayweed | United | 2010 | Inhibition of Acetolactate |
| | | Chamomile | States (Washington) | | Synthase HRAC Group 2 |
| | | | | | (Legacy B) |

In further embodiments of the subject invention, advantageous adjuvants described herein increase the effectiveness of herbicides so that less herbicide is needed to control weeds and other unwanted vegetation, and weeds otherwise resistant to the applied herbicide are terminated.

Furthermore, it has been found that compositions according to the subject invention are also suitable for the defoliation and/or desiccation of plant parts, for which crop plants such as cotton, potato, oilseed rape, sunflower, soybean or field beans, in particular cotton, are suitable. In this regard compositions of the subject invention can be used for the desiccation and/or defoliation of plants.

In a specific embodiment, a shortening of the time interval in which the individual cotton plants mature leads to an increased fiber quality after harvesting.

As desiccants, the compositions according to the invention are suitable, in particular, for desiccating the above-ground parts of crop plants such as potato, oilseed rape, sunflower and soybean, and also cereals. This helps to facilitate mechanical harvesting of these crops and allows harvesting during optimal weather conditions. If small grains, as example are left exposed to inclement weather they can develop fungal toxins (eg aflatoxin) which can ruin the grain crop. However, a negative consequence of these desiccating properties is that elevated herbicide residues are present in the final processed grain product (such as flour, rolled oats, etc.) and these elevated residues have potential human health hazards. Lowering the necessary amount of herbicide needed to affect this crop desiccation results in much lower herbicide residues in the processed consumer product.

A further advantage of the compositions and methods of the subject invention is the facilitation of harvesting of fruit, which is improved according to the subject invention by concentrating within a certain period of time the dehiscence, or reduction of adhesion to the tree, in, for example, citrus fruit, olives and other species and varieties of pomaceous fruit, stone fruit and nuts.

In specific embodiments the subject invention provides methods for pre-harvest desiccation. The crop can be, for example, a grain. In specific embodiments, the crop can be, for example, wheat, oats, barley, camelina, and other small grains, as well as pulses (e.g., lentils, dry beans, dry peas and chickpeas).

In specific embodiments, gamma-undecalactone and/or gamma-decalactone are used for pre-harvest desiccation of grains or facilitating fruit harvest.

In a further embodiment, the compositions and methods of the subject invention can be used for the termination of cover crops. Cover crops (non-crop plants used to improve, for example, soil fertility and stability) are often difficult to terminate prior to planting the primary crop, especially if they have resistant weeds growing with them. The compositions and methods of the subject invention can be used to terminate the cover crop as well as resistant weeds.

Examples of cover crops are provided in Table 2.

TABLE 2
Cover Crops

| | | Common | |
|---|---|---|---|
| Symbol | Scientific Name | Name | Plant Family |
| AVSA | Avena sativa | common oat | Poaceae-Grass family |
| AVST2 | Avena strigosa | black oats | Poaceae-Grass family |
| BRHO2 | Bromus hordeaceus | soft brome | Poaceae-Grass family |
| ECCR | Echinochloa | barnyardgrass | Poaceae-Grass family |
| | crus-galli | | |
| ELHO3 | Elymus hoffmannii | RS | Poaceae-Grass family |
| | | wheatgrass | |
| ELTR7 | Elymus | slender | Poaceae-Grass family |
| | trachycaulus | wheatgrass | |
| ERTE | Eragrostis tef | teff | Poaceae-Grass family |
| HORDE | Hordeum | barley | Poaceae-Grass family |
| HOPU | Hordeum pusillum | little barley | Poaceae-Grass family |
| HOVU | Hordeum vulgare | common | Poaceae-Grass family |
| LOMU | Lolium multiflorum | barley | Poaceae-Grass family |
| LORI | Lolium rigidum | Wimmera | Poaceae-Grass family |
| | | ryegrass | |
| LOTE2 | Lolium temulentum | Darnel | Poaceae-Grass family |
| | | ryegrass | |
| PAMI2 | Panicum miliaceum | proso millet | Poaceae-Grass family |
| PEGL2 | Pennisetum | pearl millet | Poaceae-Grass family |
| | glaucum | | |
| POPR | Poa pratensis | Kentucky | Poaceae-Grass family |
| | | bluegrass | |
| PSJU3 | Psathyrostachys | Russian | Poaceae-Grass family |
| | juncea | wildrye | |
| PUDI | Puccinellia distans | weeping | Poaceae-Grass family |
| | | alkaligrass | |
| PUNU2 | Puccinellia | Nuttall′s | Poaceae-Grass family |
| | nuttalliana | alkaligrass | |
| SECE | Secale cereale | cereal rye | Poaceae-Grass family |
| SEIT | Setaria italica | foxtail millet | Poaceae-Grass family |
| SOBI2 | Sorghum bicolor | sorghum | Poaceae-Grass family |
| SOBI5 | Sorghum bicolor | Sudex | Poaceae-Grass family |
| | var. bicolor × | | |
| | bicolor var. | | |
| | sudanense | | |
| THIN6 | Thinopyrum | intermediate | Poaceae-Grass family |
| | intermedium | wheatgrass | |
| THPO7 | Thinopyrum | tall | Poaceae-Grass family |
| | ponticum | wheatgrass | |
| TRAE | Triticum aestivum | common | Poaceae-Grass family |
| | | wheat | |
| TRITI2 | ×Triticosecale | triticale | Poaceae-Grass family |
| | [Secale × | | |
| | Triticum] | | |
| TRRI | Triticosecale | triticale | Poaceae-Grass family |
| | rimpaui [Secale | | |
| | cereale × Triticum | | |
| | aestivum] | | |
| BRRA80 | Brachiaria ramosa | | Poaceae-Grass family |
| FEME | Festuca megalura | | Poaceae-Grass family |
| ZEMA | Zea mays | corn | Poaceae-Grass family |
| CATI | Carthamus | safflower | Asteraceae-Aster |
| | tinctorius | | family |
| CIIN | Cichorium intybus | chicory | Asteraceae-Aster |
| | | | family |
| HEAN3 | Helianthus annuus | common | Asteraceae-Aster |
| | | sunflower | family |
| PHTA | Phacelia | lacy phacelia | Hydrophyllaceae- |
| | tanacetifolia | | Waterleaf family |
| AMCA3 | Amaranthus | foxtail | Amaranthaceae- |
| | caudatus | amaranth | Amaranth family |
| AMCR4 | Amaranthus | red amaranth | Amaranthaceae- |
| | cruentus | | Amaranth family |
| AMHY2 | Amaranthus | Prince-of- | Amaranthaceae- |
| | hypochondriacus | Wales | Amaranth family |
| | | feather | |
| AMHY4 | Amaranthus | Plainsman | Amaranthaceae- |
| | hybridus × | amaranth | Amaranth family |
| | hypochondriacus | | |
| BEVU2 | Beta vulgaris | common beet | Chenopodiaceae- |
| | | | Goosefoot family |
| BEVUC | Beta vulgaris | chard | Chenopodiaceae- |
| | ssp. cicla | | Goosefoot family |
| CHQU | Chenopodium | quinoa | Chenopodiaceae- |
| | quinoa | | Goosefoot family |
| SPOL | Spinacia oleracea | spinach | Chenopodiaceae- |
| | | | Goosefoot family |
| FAES2 | Fagopyrum | buckwheat | Polygonaceae |
| | esculentum | | Buckwheat family |
| BRJU | Brassica juncea | brown | Brassicaceae-Mustard |
| | | mustard | family |
| BRNAN2 | Brassica napus | rape | Brassicaceae-Mustard |
| | var. napus | | family |
| BRNAP | Brassica napus | Siberian kale | Brassicaceae-Mustard |
| | var. pabularia | | family |
| BRNI | Brassica nigra | black | Brassicaceae-Mustard |
| | | mustard | family |
| BRRAR | Brassica rapa | field mustard | Brassicaceae-Mustard |
| | var. rapa | | family |
| BRCA2 | Brassica | | Brassicaceae-Mustard |
| | campestris | | family |
| CASA2 | Camelina sativa | false flax | Brassicaceae-Mustard |
| | | | family |
| ERVES | Eruca vesicaria | rocketsalad | Brassicaceae-Mustard |
| | ssp. sativa | | family |
| RASA2 | Raphanus sativus | cultivated | Brassicaceae-Mustard |
| | | radish | family |
| BRHI2 | Brassica hirta | | Brassicaceae-Mustard |
| | | | family |
| CUCUR | Cucurbita | gourd | Cucurbitaceae |
| | | | Cucumber family |
| DACAS2 | Daucus carota | carrot | Apiaceae-Carrot |
| | var. sativus | | family |
| ARGL18 | Arachis glabrata | rhizoma | Fabaceae-Pea family |
| | | peanut | |
| ARHY | Arachis hypogaea | peanut | Fabaceae-Pea family |
| CACA27 | Cajanus cajan | pigeonpea | Fabaceae-Pea family |
| CAEN4 | Canavalia | jack bean | Fabaceae-Pea family |
| | ensiformis | | |
| CIAR5 | Cicer arietinum | chick pea | Fabaceae-Pea family |
| CRJU | Crotalaria juncea | sunn hemp | Fabaceae-Pea family |
| CYTE11 | Cyamopsis | guar | Fabaceae-Pea family |
| | tetragonoloba | | |
| GLMA4 | Glycine max | soybean | Fabaceae-Pea family |
| INHI | Indigofera hirsuta | | Fabaceae-Pea family |
| LAPU6 | Lablab purpureus | hyacinthbean | Fabaceae-Pea family |
| LASA2 | Lathyrus sativus | white pea | Fabaceae-Pea family |
| LASY | Lathyrus sylvestris | flat pea | Fabaceae-Pea family |
| LECU2 | Lens culinaris | lentil | Fabaceae-Pea family |
| LECA8 | Lespedeza capitata | roundhead | Fabaceae-Pea family |
| | | lespedeza | |
| LOCO6 | Lotus corniculatus | bird′s-foot | Fabaceae-Pea family |
| | | trefoil | |
| LOTE4 | Lotus tenuis | narrowleaf | Fabaceae-Pea family |
| | | trefoil | |
| LUPIN | Lupinus | lupine | Fabaceae-Pea family |
| LUAL22 | Lupinus albus | white lupine | Fabaceae-Pea family |
| LUAN4 | Lupinus | narrowleaf | Fabaceae-Pea family |
| | angustifolius | lupine | |
| MELIS | Medicago littoralis | water medick | Fabaceae-Pea family |
| MELU | Medicago lupulina | black medick | Fabaceae-Pea family |
| MEPO3 | Medicago | burclover | Fabaceae-Pea family |
| | polymorpha | | |
| MERU3 | Medicago rugosa | | Fabaceae-Pea family |
| MESA | Medicago sativa | alfalfa | Fabaceae-Pea family |
| MESC6 | Medicago | snail medick | Fabaceae-Pea family |
| | scutellata | | |
| METR10 | Medicago | barrelclover | Fabaceae-Pea family |
| | truncatula | | |
| MEIN2 | Melilotus indicus | annual yellow | Fabaceae-Pea family |
| | | sweetclover | |
| MEOF | Melilotus | sweetclover | Fabaceae-Pea family |
| | officinalis | | |
| MEAL12 | Melilotus alba | | Fabaceae-Pea family |
| MUPR | Mucuna pruriens | velvet bean | Fabaceae-Pea family |
| ONVI | Onobrychis | sainfoin | Fabaceae-Pea family |
| | viciifolia | | |
| PISA6 | Pisum sativum | garden pea | Fabaceae-Pea family |
| SEBI3 | Sesbania bispinosa | dunchi fiber | Fabaceae-Pea family |
| SEAC7 | Sesbania aculeata | | Fabaceae-Pea family |
| SEEX | Sesbania exaltata | | Fabaceae-Pea family |
| SESE8 | Sesbania sesban | Egyptian | Fabaceae-Pea family |
| | | riverhemp | |
| TRAL6 | Trifolium | Egyptian | Fabaceae-Pea family |
| | alexandrinum | clover | |
| TRAM15 | Trifolium | Kura clover | Fabaceae-Pea family |
| | ambiguum | | |
| TRFR2 | Trifolium | strawberry | Fabaceae-Pea family |
| | fragiferum | clover | |
| TRHI4 | Trifolium hirtum | rose clover | Fabaceae-Pea family |
| TRHY | Trifolium hybridum | alsike clover | Fabaceae-Pea family |
| TRIN3 | Trifolium | crimson | Fabaceae-Pea family |
| | incarnatum | clover | |
| TRPR2 | Trifolium pratense | red clover | Fabaceae-Pea family |
| TRRE3 | Trifolium repens | white clover | Fabaceae-Pea family |
| TRSU3 | Trifolium | subterranean | Fabaceae-Pea family |
| | subterraneum | clover | |
| TRVE | Trifolium | arrowleaf | Fabaceae-Pea family |
| | vesiculosum | clover | |
| TRIGO | Trigonella | fenugreek | Fabaceae-Pea family |
| VIBE | Vicia benghalensis | | Fabaceae-Pea family |
| VIAT2 | Vicia atropurpurea | | Fabaceae-Pea family |
| VIFA | Vicia faba | fava bean | Fabaceae-Pea family |
| VIGR | Vicia grandiflora | large yellow | Fabaceae-Pea family |
| | | vetch | |
| VISA | Vicia sativa | garden vetch | Fabaceae-Pea family |
| VIVI | Vicia villosa | winter vetch | Fabaceae-Pea family |
| VIRA4 | Vigna radiata | mung bean | Fabaceae-Pea family |
| VIUN | Vigna unguiculata | cowpea | Fabaceae-Pea family |
| LIUS | Linum | common flax | Linaceae-Flax family |
| | usitatissimum | | |

In one embodiment, the subject invention provides a method that comprises exposing a plant to a selected known herbicide at recommended dose (or up to 90% lower than recommended), and a compound from Table 3, Table 4 or Table 5, or any combination thereof (concentrations ranging, for example, from 0.1%-10% v/v or w/v). Exposure to the compound can occur either in the vapor state or in a liquid soluble state sprayed on the shoots or applied directly to the soil.

TABLE 3

| Code | |
|---|---|
| Name | Compound Name |
| DRG1 | phenethyl butyrate |
| GDS19 | isoamyl salicylate |
| GDS22 | butyl salicylate |
| GDS6 | Benzyl Benzoate |
| DRG2 | iso-amyl butyrate |
| GDS1 | benzyl salicylate |
| NTR15 | Geranyl Formate |
| NTR7 | Citronellyl Formate |
| HINT5 | gamma-Cyclodextrin |

TABLE 4
Representative categories of active compounds

| General | | | | |
|---|---|---|---|---|
| Formula | | | | Non-limiting |
| No. | Category | Core Structure | R groups | Examples |
| 1 | Lactones | 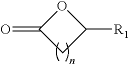 | R¹ = e.g., H; halogens (F, Cl, Br, I); hydroxyl, alkyl, vinyl and/or aryl | Gamma lactones Delta lactones Epsilon lactones |
| | | n = integer ≥ 1 | groups. | |
| | | | In some | |
| | | | embodiments, one | |
| | | | or more saturated | |
| | | | bonds may be | |
| | | | substituted with | |
| | | | unsaturated bonds | |
| | | | within the carbon | |
| | | | ring. | |
| 2 | Lactones | 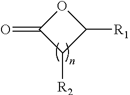 | R¹ and R² = e.g., H; halogens (F, Cl, Br, I); hydroxyl, alkyl, vinyl and/or aryl groups. In some | Gamma lactones Delta lactones Epsilon lactones |
| | | n = integer ≥ 1 | embodiments, one | |
| | | | or more saturated | |
| | | | bonds may be | |
| | | | substituted with | |
| | | | unsaturated bonds | |
| | | | within the carbon | |
| | | | ring. | |
| 3 | Gamma lactones (5- membered lactones) | 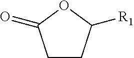 | R¹ = e.g., H; halogens (F, Cl, Br, I); various alkyl groups (CₙH₂ₙ₊₁, | Gammavalerolactone Gammabutyrolactone Gammaoctalactone Gammanonalactone |
| | | | where n = integer ≥ | |
| | | | 1). | |
| 4 | Delta lactones (6-membered lactones) | 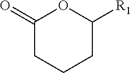 | R¹ = e.g., H, halogens (F, Cl, Br, I) and/or various alkyl groups (CₙH₂ₙ₊₁, where n = | Delta-decalactone Delta-octalactone Delta-hexalactone Delta-undecalactone |
| | | | integer ≥ 1). | |
| 5 | Epsilon lactones (7-membered lactones) | 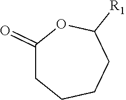 | R¹ = e.g., H, halogens (F, Cl, Br, I) and/or various alkyl groups (CₙH₂ₙ₊₁, where n = integer ≥ 1). | Caprolactone 7-methylcaprolactone |
| 6 | Formates | 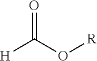 | R = halogens (F, Cl, Br, I), alkyl, cycloalkyl, allyl, benzyl and/or | Alkyl formates, such as, e.g., methyl formate, ethyl formate, propyl |
| | | | phenyl-based | formate, isopropyl |
| | | | groups. | formate, butyl |
| | | | | formate, sec-butyl |
| | | | | formate, iso-amy1 |
| | | | | formate, hexyl |
| | | | | formate, octyl formate |
| | | | | and decyl formate; |
| | | | | Unsaturated alkyl |
| | | | | formates, such as, |
| | | | | e.g., allyl formate, |
| | | | | vinyl formate, (E/Z)- |
| | | | | hezenyl formate and |
| | | | | prenyl formate; |
| | | | | Cycloalkyl formates, |
| | | | | such as, e.g., |
| | | | | cyclohexyl formate, |
| | | | | cyclooctyl formate |
| | | | | and cyclodecyl |
| | | | | formate; and |
| | | | | Aromatic or benzyl |
| | | | | formates, such as, |
| | | | | e.g., benzyl formate, |
| | | | | phenethyl formate and |
| | | | | cinnamyl formate |
| | | | | (E/Z). |
| 7 | Aromatic | R¹—O—CO—Ar—R² | R¹ = halogens (F, | Phenyl salicylate |
| | ester derivatives (benzoates, salicylates & cinnamates) | 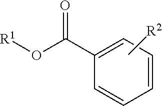 | Cl, Br, I), benzyl, phenethyl, cinnamyl and/or alkyl. Ar = phenyl R² = halogens (F, Cl, Br, I), OH, | |
| | | | OCH₃, alkyl and/or | |
| | | | H. | |
| 8 | Phenyl- | R¹—Ph—CH═CH—CH₂—O—CO—R² | R¹ = OCH₃, OH, | Isoeugenol acetate |
| | propanoid esters | 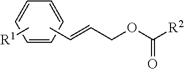 | halogens (F, Cl, Br, I), and/or alkyl. R² = acetate, butyrate, benzoate, and/or halogens (F, | |
| | | | Cl, Br, I). | |
| 9 | Chalcone-like | R¹—Ar¹—CH—CH—CO—Ar²—R² | R¹ and R² = OH, | Dehydrozingerone |
| | compounds | 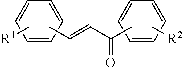 | OCH₃, halogens (F, Cl, Br, I), and/or an aromatic. Ar¹ and Ar² = phenyl rings | |
| 10 | Polyphenolic and/or flavonoid derivatives | 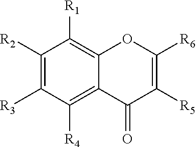 | R¹⁻⁶ = H, OH, OCH₃, halogens (F, Cl, Br, I), and/or prenyl groups. | Acacetin |
| 11 | Straight-chain | CH₃—(CH₂)ₙ—COOH | | Palmitic Acid |
| | fatty acids | 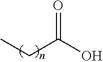 | | Pelargonic Acid Capric Acid Caprylic Acid Oleic Acid |
| | | n = integer ≥ 1, e.g., 2 to 18 | | Linoleic Acid |
| 12 | Poly- hydroxy- lated aromatics/ carbohydrates (glycosides) | 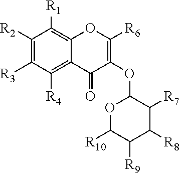 | R¹⁻¹⁰ = halogens (F, Cl, Br, I), glycoside sugars and/or OH. | Myrictrin |
| 13 | Cresyl | R¹—C₆H₄—O—CO—C₆H₄—OH | R1 = halogens (F, | Para-cresyl salicylate |
| | salicylate derivatives | 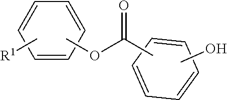 | Cl, Br, I), para- cresyl (4-CH₃—Ph), ortho-cresyl (2- CH₃—Ph), phenethyl (—CH₃—CH₂—Ph), guaiacyl (2- | Ortho-cresyl salicylate Meta-cresyl salicylate Phenyl salicylate Phenethyl salicylate Guaiacyl salicylate Prenyl salicylate |
| | | | methoxyphenyl), | 2-methyl butyl salicylate |
| | | | prenyl (3- | 3-phenyl propyl salicylate |
| | | | methylbut-2-en-1- | |
| | | | yl), 2-methylbutyl | |
| | | | and/or 3- | |
| | | | phenylpropyl. | |
| 14 | Benzyl and/or | R¹—CH₂—O—CO—C₆H₅ | R¹ = halogens (F, | Benzyl benzoate |
| | cinnamyl benzoates | 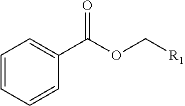 | Cl, Br, I), benzyl (Ph—CH₂) and/or cinnamyl (3- phenylprop-2-enyl). | Cinnamyl benzoate Benzyl phenyl carbinol Benzyl para- anisate Benzyl valerate Benzyl nicotinate |
| 15 | Benzyl | C₆H₅—CH₂—O—CO—R¹ | R1 = halogens (F, | Benzyl nicotinate |
| | derivatives | 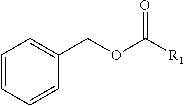 | Cl, Br, I), nicotinic acid (3- pyridinecarboxylic acid), levulinic acid (4-oxopentanoic acid) and/or phenylcarbinol | Benzyl anthranilate Benzyl levulinate Benzyl eugenol |
| | | | (Ph—CH—OH). | |
| 16 | Salicylate | R¹—CH₂—O—CO—C₆H—OH | R¹ = halogens (F, | Benzyl salicylate |
| | esters | 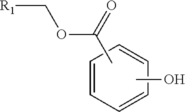 | Cl, Br, I), benzyl (Ph—CH₂), guaiacyl (2-methoxyphenyl), isoamyl (3- methylbutyl), prenyl (3- methylbut-2-enyl), | Guaiacyl salicylate Prenyl salicylate Phenyl salicylate Ortho-cresyl salicylate Phenethyl salicylate Cinnamyl salicylate |
| | | | phenyl, cinnamyl | Isoamyl salicylate |
| | | | (Ph—CH═CH—CH₂—), | Butyl salicylate |
| | | | phenethyl | Hexyl salicylate |
| | | | (Ph—CH₂—CH₂— ) | Allyl salicylate |
| | | | and/or | 2-methyl butyl |
| | | | alkyl/alkenyl | salicylate |
| | | | groups (e.g., butyl, | 3-phenyl propyl |
| | | | hexyl, allyl). | salicylate |
| 17 | Anthranilate | R¹—O—CO—C₆H₄—NH₂ | R1 = halogens (F, | Benzyl anthranilate |
| | derivatives | 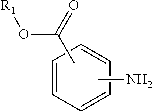 | Cl, Br, I), benzyl (Ph—CH₂), phenethyl (Ph—CH₂—CH₂—), isoamyl (3- methylbutyl) and/ or amyl (pentyl). | Phenethyl anthranilate Isoamyl anthranilate Amyl anthranilate |
| 18 | Phenethyl | R¹—O—CO—CH₃ | R1 = halogens (F, | Cinnamyl acetate |
| | and/or cinnamyl acetate derivatives | 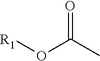 | Cl, Br, I), cinnamyl (Ph—CH═CH—CH₂—), phenethyl (Ph- CH₂—CH₂—) and/or | Phenethyl benzoate Phenethyl acetate Phenethyl propanoate Phenethyl lactate |
| | | | other related | Phenethyl sorbate |
| | | | phenylalkyl | Phenethyl resorcinol |
| | | | substituents. | |
| 19 | Cinnamate | R¹—O—CO—CH═CH—C₆H₅ | R¹ = halogens (F, | Ethyl (E)-cinnamate |
| | esters | 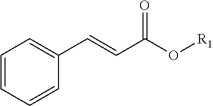 | Cl, Br, I), ethyl, benzyl (Ph—CH₂), cinnamyl (Ph—CH═CH—CH₂—), butyl, hexyl, straight-chain alkyl groups. | Cinnamyl acetate Cinnamyl benzoate Cinnamyl cinnamate |
| 20 | Valerate | R¹—O—CO—(CH₂)₃—CH₃ | R¹ = halogens (F, | Benzyl valerate |
| | derivatives | 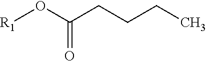 | Cl, Br, I), benzyl (Ph—CH₂) and/or cinnamyl (Ph—CH═CH—CH₃). | |

TABLE 5
Active Compounds

| Code | Compound name |
|---|---|
| HGRA-1 | piperine |
| HGRA-4 | Dehydrozingerone |
| HGRA-5 | Myricitrin |
| HGRA-6 | NONIVAMIDE |
| HGRA-7 | Valeric acid |
| HGRA-8 | 2-Phenylethyl hexanoate |
| HGRA-9 | Phenyl salicylate |
| HGRA-10 | Isoeugenol |
| HGRA-12 | Isoquercitrin |
| HGRA-13 | Phenethyl decanoate |
| HGRA-14 | Phenethyl octanoate |
| HGRA-15 | 3-Phenylpropionic acid |
| HGRA-16 | N-benzoylanthranilic acid |
| HGRA-17 | Caproic Acid |
| HGRA-18 | Phenethyl butyrate |
| HGRA-19 | Benzyl butyrate |
| HGRA-20 | Methyl 2-furoate |
| HGRA-21 | 2-Methylbenzyl acetate |
| HGRA-22 | 2-Methyl-3-phenylpropanal |
| HGRA-23 | 2-Methyl-3-phenylpropionic acid |
| HGRA-24 | Vanillin |
| HGRA-25 | 2-Methoxy-4-methylphenol |
| HGRA-26 | 2-Methoxy-4-propylphenol |
| HGRA-27 | 2-Methoxybenzaldehyde |
| HGRA-28 | 2-Methoxybenzyl acetate |
| HGRA-29 | Cinnamyl butyrate |
| HGRA-30 | Cinnamyl acetate |
| HGRA-31 | Phenethyl acetate |
| HINT-1 | alpha-Cyclodextrin |
| HINT-2 | Benzaldehyde, 4-hydroxy-3-methoxy- |
| HINT-3 | Tetradecanoic acid, potassium salt |
| HINT-5 | gamma-Cyclodextrin |
| HINT-7 | Wintergreen oil |
| HINT-8 | Lanolin |
| HINT-9 | Dextrins |
| HINT-10 | Locust bean gum |
| HINT-13 | Magnesium benzoate |
| HINT-17 | 9-Octadecenoic acid, 12-hydroxy-, |
| | monopotassium salt, (9Z, 12R)- |
| HACT-2 | oleic acid |
| HACT-3 | palmitoleic acid |
| HACT-4 | myristic acid |
| HACT-5 | palmitic acid |
| HACT-6 | stearic acid |
| HACT-7 | linoleic acid |
| HACT-8 | eugenyl acetate |
| HACT-10 | lauryl sulfate |
| HACT-11 | geranyl acetate |
| HACT-12 | malic acid |
| HACT-13 | Geraniol |
| HACT-14 | 3-Methylthiophene |
| NGDS-1 | Resveratrol |
| NGDS-2 | benzyl salicylate |
| NGDS-3 | guaiacyl salicylate |
| NGDS-4 | Chalconaringenin |
| NGDS-5 | para-cresyl salicylate |
| NGDS-6 | benzoyl anthranilic acid |
| NGDS-7 | para-anisyl salicylate |
| NGDS-8 | para-cresyl 3-methyl crotonate |
| NGDS-9 | prenyl salicylate |
| NGDS-10 | phenyl salicylate |
| NGDS-11 | 1-(2-hydroxyphenyl)-3- |
| | (pyridin-4-yl)propan-1-one |
| NGDS-12 | ortho-cresyl salicylate |
| NGDS-13 | para-anisyl benzoate |
| NGDS-14 | benzyl anthranilate |
| NGDS-15 | phenethyl salicylate |
| NGDS-16 | acetaminosalol |
| NGDS-17 | 2-Phenylethyl 2-furancarboxylate |
| NGDS-18 | beta-naphthyl benzoate |
| NGDS-19 | 2-(2-phenyl ethyl) chromone |
| NGDS-20 | beta-naphthyl anthranilate |
| NGDS-21 | 4-dihydromethyl-2H-pyran-2-yl guaiacol |
| NGDS-22 | cinnamyl salicylate |
| NGDS-23 | benzyl nicotinate |
| NGDS-24 | Flavones |
| NGDS-25 | phenethyl resorcinol |
| NGDS-26 | Acacetin |
| NGDS-27 | eriodictyol |
| NGDS-28 | Phloretin |
| NGDS-29 | 2-Phenylethyl 2-aminobenzoate |
| NGDS-30 | aromadedrin |
| NGDS-31 | Benzoyl peroxide |
| NGDS-32 | heliotropyl phenyl acetate |
| NGDS-33 | Chalcone |
| NGDS-34 | benzyl para-anisate |
| NGDS-35 | cinnamyl anthranilate |
| NGDS-36 | (Z)-2-penten-1-yl benzoate |
| NGDS-37 | 2-naphthyl phenyl ketone |
| NGDS-38 | bergamottin |
| NGDS-39 | Isoimperatorin |
| NGDS-40 | para-cresyl benzoate |
| NGDS-41 | guaiacyl benzoate |
| NGDS-42 | Caffeic acid ethyl ester |
| NGDS-43 | 4-phenyl propyl pyridine |
| NGDS-44 | 2-Phenylethyl benzoate |
| NGDS-45 | Benzyl Benzoate |
| NGDS-46 | 2-methyl butyl salicylate |
| NGDS-47 | phenethyl sorbate |
| NGDS-48 | para-anisaldehyde/methyl anthranilate schiff′s base |
| NGDS-49 | Dibenzyl ether |
| NGDS-50 | ortho-anisyl benzoate |
| NGDS-51 | Cinnamyl benzoate |
| NGDS-52 | 1-(2-hydroxy-4-methoxyphenyl)- |
| | 3-(pyridin-2-yl)propan-1-one |
| NGDS-53 | Ethyl 4-methylphenoxyacetate |
| NGDS-54 | Benzyl trans-2-methyl-2-butenoate |
| NGDS-55 | \alpha,alpha-dimethyl anisyl acetone\ |
| NGDS-56 | styryl acetate |
| NGDS-57 | amyl cinnamate |
| NGDS-58 | ortho-cresyl benzoate |
| NGDS-59 | methyl phenyl methylene aminobenzoate |
| NGDS-60 | phenethyl pyridine |
| NGDS-61 | (Z)-N-Coumaroyl-5-hydroxyanthranilic acid |
| NGDS-62 | homoeriodictyol |
| NGDS-63 | Benzyl 2,3-dimethyl-2-butenoate |
| NGDS-64 | meta-cresyl benzoate |
| NGDS-65 | (Z)-anisylidene acetone |
| NGDS-66 | guaiacyl phenyl acetate |
| NGDS-67 | 3-phenyl propyl salicylate |
| NGDS-68 | geranyl cantabiline |
| NGDS-69 | cortex pyridine |
| NGDS-70 | ethyl para-cresyl carbonate |
| NGDS-71 | ethyl phenoxyacetate |
| NGDS-72 | Hesperetin |
| NGDS-73 | \3′,7-dihydroxy-4′-methoxyflavan\ |
| NGDS-74 | allyl (Z)-cinnamate |
| NGDS-75 | Bisdemethoxycurcumin |
| NGDS-76 | Amyl salicylate |
| NGDS-77 | phenyl acetaldehyde/methyl anthranilate schiff′s base |
| NGDS-78 | p-Tolyl phenylacetate |
| NGDS-79 | 4-formyl phenyl butyrate |
| NGDS-80 | 4-Methoxybenzyl phenylacetate |
| NGDS-81 | para-cresyl 3-oxo-3-phenyl propionate |
| NGDS-82 | (E)-2-hexen-1-yl salicylate |
| NGDS-83 | furfuryl phenyl acetate |
| NGDS-84 | butyl 2-naphthyl ether |
| NGDS-85 | (E)-cinnamyl acetate |
| NGDS-86 | Cinnamyl acetate |
| NGDS-87 | ethyl (E)-cinnamate |
| NGDS-88 | Ethyl cinnamate |
| NGDS-89 | 2-para-cresyl oxyethyl acetate |
| NGDS-90 | neryl anthranilate |
| NGDS-91 | cinnamaldehyde/methyl anthranilate schiff′s base |
| NGDS-92 | cinnamyl tiglate |
| NGDS-93 | (E)-cinnamyl propionate |
| NGDS-94 | 1-(4-Methoxyphenyl)-1-penten-3-one |
| NGDS-95 | Imperatorin |
| NGDS-96 | para-cresyl valerate |
| NGDS-97 | meta-cresyl phenyl acetate |
| NGDS-98 | 3-methyl-3-buten-1-yl benzoate |
| NGDS-99 | para-anisyl acetoacetate |
| NGDS-100 | isoamyl p-methoxycinnamate |
| NGDS-101 | isoeugenyl benzoate |
| NGDS-102 | (Z)-3-hexen-1-yl cinnamate |
| NGDS-103 | Eugenyl benzoate |
| NGDS-104 | isoamyl salicylate |
| NGDS-105 | Phenylmethyl benzeneacetate |
| NGDS-106 | curcumin |
| NGDS-107 | butyl cinnamate |
| NGDS-108 | cinnamyl acetoacetate |
| NGDS-109 | para-cresyl phenyl ether |
| NGDS-110 | citral/methyl anthranilate schiff′s base |
| NGDS-111 | cinnamyl valerate |
| NGDS-112 | Allyl phenoxyacetate |
| NGDS-113 | 2-Phenylethyl 3-phenyl-2-propenoate |
| NGDS-114 | geranyl benzoate |
| NGDS-115 | (E)-3-butylidene phthalide |
| NGDS-116 | geranyl cinnamate |
| NGDS-117 | neryl cinnamate |
| NGDS-118 | cinnamyl cinnamate |
| NGDS-119 | amyl anthranilate |
| NGDS-120 | benzyl (E)-isoeugenol |
| NGDS-121 | Isoeugenol benzyl ether |
| NGDS-122 | cinnamyl phenyl acetate |
| NGDS-123 | Phenethyl phenylacetate |
| NGDS-124 | (R)-benzoin |
| NGDS-125 | (S)-benzoin |
| NGDS-126 | Benzoin |
| NGDS-127 | benzyl eugenol |
| NGDS-128 | 4-Methylphenyl 3-methylbutanoate |
| NGDS-129 | (Z)-3-hexen-1-yl salicylate |
| NGDS-130 | dibenzyl |
| NGDS-131 | 3-phenyl propyl benzoate |
| NGDS-132 | Oxypeucedanin hydrate |
| NGDS-133 | Psoralen |
| NGDS-134 | methyl (para-tolyl oxy) acetate |
| NGDS-135 | butyl salicylate |
| NGDS-136 | Butylparaben |
| NGDS-137 | sophoraflavanone B |
| NGDS-138 | isoamyl anthranilate |
| NGDS-139 | xanthohumol |
| NGDS-140 | 2-hydroxyethyl phenoxyacetate |
| NGDS-141 | propyl cinnamate |
| NGDS-142 | Pentyl benzoate |
| NGDS-143 | (R)-delta-undecalactone |
| NGDS-144 | (E)-cinnamyl butyrate |
| NGDS-145 | diphenethyl ether |
| NGDS-146 | \2,5-distyryl pyrazine\ |
| NGDS-147 | Bergaptol |
| NGDS-148 | Bergaptol |
| NGDS-149 | butyl para-anisate |
| NGDS-150 | benzyl (E)-crotonate |
| NGDS-151 | turmeric root oil vietnam |
| NGDS-152 | citrus red 2 |
| NGDS-153 | Piperine |
| NGDS-154 | isoeugenyl phenyl acetate |
| NGDS-155 | ivy carbaldehyde/methyl anthranilate schiff′s base |
| NGDS-156 | isoamyl (E)-cinnamate |
| NGDS-157 | meta-cresyl phenyl ether |
| NGDS-158 | cinnamaldehyde butylene glycol acetal |
| NGDS-159 | (Z)-3-hexen-1-yl anthranilate |
| NGDS-160 | phenethyl oxyacetaldehyde |
| NGDS-161 | Shikonin |
| NGDS-162 | phenethyl lactate |
| NGDS-163 | eugenyl phenyl acetate |
| NGDS-164 | 2-methyl butyl benzoate |
| NGDS-165 | (Z)-3-hexen-1-yl anisate |
| NGDS-166 | 3-(2-Furanyl)-2-phenyl-2-propenal |
| NGDS-167 | para-cresyl hexanoate |
| NGDS-168 | cinnamyl hexanoate |
| NGDS-169 | 1,3-Diphenyl-2-propanone |
| NGDS-170 | butyl anthranilate |
| NGDS-171 | hexyl cinnamate |
| NGDS-172 | heraclenol |
| NGDS-173 | cinnamyl eugenol |
| NGDS-174 | phenethyl tiglate |
| NGDS-175 | eugenyl 2-methyl-2-butenoate |
| NGDS-176 | 1-(2-phenyl ethoxy)-2-(4-methyl phenoxy)ethanol |
| NGDS-177 | annatto seed extract (solvent-extracted bixin) |
| NGDS-178 | linalyl anthranilate |
| NGDS-179 | 3-phenyl propyl cinnamate |
| NGDS-180 | 2,5-Dimethyl-1,4-dithiane-2,5-diol |
| NGDS-181 | annatto seed extract (solvent-extracted norbixin) |
| NGDS-182 | annatto seed powder |
| NGDS-183 | benzyl phenyl carbinol |
| NGDS-184 | (E)-3-hexen-1-yl benzoate |
| NGDS-185 | cis-3-Hexenyl benzoate |
| NGDS-186 | 2-Propenyl 2-aminobenzoate |
| NGDS-187 | allyl salicylate |
| NGDS-188 | para-anisyl isobutyrate |
| NGDS-189 | 2-Phenylethyl pentanoate |
| NGDS-190 | 3-methyl dibenzothiophene |
| NGDS-191 | O-geranyl vanillin |
| NGDS-192 | Benzyl 2-methylbutanoate |
| NGDS-193 | Amyl phenylacetate |
| NGDS-194 | phellopterin |
| NGDS-195 | \1,3-dimethyl-3-butenyl salicylate\ |
| NGDS-196 | geranyl phenyl acetate |
| NGDS-197 | Geranyl phenylacetate |
| NGDS-198 | cinnamyl 2-methyl butyrate |
| NGDS-199 | cyclohexyl cinnamate |
| NGDS-200 | Linalyl cinnamate |
| NGDS-201 | (E)-2-hexen-1-yl phenyl acetate |
| NGDS-202 | cis-3-Hexenyl phenylacetate |
| NGDS-203 | benzyl valerate |
| NGDS-204 | 3-phenyl propyl crotonate |
| NGDS-205 | 2-isopropoxyethyl salicylate |
| NGDS-206 | 2-Phenylethyl 3-methyl-2-butenoate |
| NGDS-207 | gamma-Mangostin |
| NGDS-208 | 2-phenoxyethyl formate |
| NGDS-209 | phenyl propyl phenyl acetate |
| NGDS-210 | 2-Phenylethyl acetate |
| NGDS-211 | 2-Phenylethyl propanoate |
| NGDS-212 | benzyl levulinate |
| NGDS-213 | hexyl salicylate |
| NGDS-214 | magnolol |
| NGDS-215 | para-cresyl butyrate |
| NGDS-216 | isobutyl para-anisate |
| NGDS-217 | Irisone B |
| NGDS-218 | S-methyl thiopropionate |
| NGDS-219 | Herniarin |
| NGDS-220 | 2-(Phenylethenyl)-1,3-dioxolane |
| NGDS-221 | lactoyl tyramine |
| NGDS-222 | cuminyl phenyl acetate |
| NGDS-223 | trilobatin |
| NGDS-224 | Ethyl 3-oxo-3-phenylpropanoate |

Improvements of herbicidal activity can be confirmed by, for example, quantifying the plant death and checking for increases upon addition of adjuvant, particularly when no or minimal significant effect is found for either compound alone.

The methods and compositions according to the subject invention can be applied in conventional manner by using techniques with which a skilled person is familiar. Suitable techniques include spraying, atomizing, dusting, spreading or watering.

In preferred embodiments, the compositions according to the subject invention are applied to plants by spraying the leaves. The application can be carried out using, for example, water as carrier by customary spraying techniques using spray liquor amounts of from about 10 to 100 l/ha (for example from 300 to 400 l/ha).

### Definitions

As used herein, the singular forms “a”, “an”, and “the” are intended to include the plural forms as well, unless the context clearly indicates otherwise. Furthermore, to the extent that the terms “including”, “includes”, “having”, “has”, “with”, or variants thereof are used in either the detailed description and/or the claims, such terms are intended to be inclusive in a manner similar to the term “comprising”. The transitional terms/phrases (and any grammatical variations thereof) “comprising”, “comprises”, and “comprise” can be used interchangeably; “consisting essentially of”, and “consists essentially of” can be used interchangeably; and “consisting”, and “consists” can be used interchangeably.

The transitional term “comprising,” “comprises,” or “comprise” is inclusive or open-ended and does not exclude additional, unrecited elements or method steps. By contrast, the transitional phrase “consisting of” excludes any element, step, or ingredient not specified in the claim. The phrases “consisting” or “consists essentially of” indicate that the claim encompasses embodiments containing the specified materials or steps and those that do not materially affect the basic and novel characteristic(s) of the claim. Use of the term “comprising” contemplates other embodiments that “consist” or “consisting essentially of” the recited component(s).

The term “about” or “approximately” means within an acceptable error range for the particular value as determined by one of ordinary skill in the art, which will depend in part on how the value is measured or determined, i.e., the limitations of the measurement system. For example, “about” can mean within 1 or more than 1 standard deviation, per the practice in the art. Alternatively, “about” can mean a range of up to 0-20%, 0 to 10%, 0 to 5%, or up to 1% of a given value. Alternatively, particularly with respect to biological systems or processes, the term can mean within an order of magnitude, preferably within 5-fold, and more preferably within 2-fold, of a value. Where particular values are described in the application and claims, unless otherwise stated the term “about” meaning within an acceptable error range for the particular value should be assumed. In the context of compositions containing amounts of concentrations of ingredients where the term “about” is used, these values include a variation (error range) of 0-10% around the value (X±10%).

In the present disclosure, ranges are stated in shorthand to avoid having to set out at length and describe each and every value within the range. Any appropriate value within the range can be selected, where appropriate, as the upper value, lower value, or the terminus of the range. For example, a range of 0.1-1.0 represents the terminal values of 0.1 and 1.0, as well as the intermediate values of 0.2, 0.3, 0.4, 0.5, 0.6, 0.7, 0.8, 0.9, and all intermediate ranges encompassed within 0.1-1.0, such as 0.2-0.5, 0.2-0.8, 0.7-1.0, etc. Values having at least two significant digits within a range are envisioned, for example, a range of 5-10 indicates all the values between 5.0 and 10.0 as well as between 5.00 and 10.00 including the terminal values. When ranges are used herein, combinations and subcombinations of ranges (e.g., subranges within the disclosed range) and specific embodiments therein are explicitly included.

As used herein, “applying” a composition or product to a site refers to contacting a composition or product with a site such that the composition or product can have an effect on that site.

As used herein, the term “plant” includes, but is not limited to, any species of woody, ornamental or decorative, crop or cereal, aquatic plant (crop or weed growing in bodies of water), turf grass, range grasses, any weed species, cover crops, fruit plant or vegetable plant, flower or tree, macroalga or microalga, phytoplankton and photosynthetic algae (e.g., green algae Chlamydomonas reinhardtii). “Plant” also includes a unicellular plant (e.g., microalga) and a plurality of plant cells that are largely differentiated into a colony (e.g., volvox) or a structure that is present at any stage of a plant's development. Such structures include, but are not limited to, a fruit, a seed, a shoot, a stem, a leaf, a root, a flower petal, etc. Plants can be standing alone, for example, in a garden, or can be one of many plants, for example, as part of an orchard, crop (or crop weed complexes), pasture, multi-species cover crops or fallow land populated by numerous weed species.

As used herein, the term “resistant weed(s)” refers to a plant that, in relation to a treatment with an approved label-appropriate or over-appropriate rate of herbicidal application, has inherited, developed or acquired an ability:
(1) to survive that treatment, if it is one that is lethal to the wild type weed; and/or
(2) to exhibit significant vegetative growth or thrive after that treatment, if it is one that suppresses growth of the wild-type weed.

The term “effective amount” denotes an amount of the active ingredient that is sufficient to yield a desired effect such as controlling unwanted plants or improving characteristics of the plants in anticipation of, for example, harvesting, and which does not result in a substantial damage to desired plants. Such an amount can vary and is dependent on various factors, such as the plants to be controlled, the treated crop or material, the climatic conditions and the specific composition according to the invention used.

Unless otherwise defined, all terms of art, notations and other scientific terms or terminology used herein are intended to have the meanings commonly understood by those of skill in the art to which this invention pertains. In some cases, terms with commonly understood meanings are defined herein for clarity and/or for ready reference, and the inclusion of such definitions herein should not necessarily be construed to represent a substantial difference over what is generally understood in the art. It will be further understood that terms, such as those defined in commonly used dictionaries, should be interpreted as having a meaning that is consistent with their meaning in the context of the relevant art and/or as otherwise defined herein.

### Methods of Controlling Unwanted Vegetation

The subject invention can be practiced with standard methods and equipment that are used for, for example, maintenance of farmland, other agriculture areas, industrial sites, pastures, bodies of water, homeowner landscapes and gardens. For example, the herbicidal composition can be applied in liquid form using a standard spray boom or an irrigation system. The composition can also be applied as a granule, as a coating (e.g., seed coating), or impregnated into prills. Additionally, the composition can be applied using a manual spreader, such as a broadcast spreader, a drop spreader, a handheld spreader, or a handheld sprayer. The composition can also be applied using aerial spreading (e.g., crop dusting), by, for example, airplane, helicopter, or drone.

In certain embodiments, the user applies the agrochemical composition according to the invention from a pre-dosage device, a knapsack sprayer, a spray tank, a spray plane, or an irrigation system. Typically, in this embodiment, the agrochemical composition is made up with water, buffer, and/or further auxiliaries to the desired application concentration and the ready-to-use spray liquor or the agrochemical composition according to the invention is thus obtained. In specific embodiments, 10 to 2000 liters, preferably 50 to 400 liters, of the ready-to-use spray liquor are applied per hectare of agricultural useful area.

According to one embodiment, either individual components of the agrochemical composition according to the invention or partially premixed components, e.g., agrochemical components comprising a herbicide and an adjuvant may be mixed by the user in a spray tank and further auxiliaries and additives may be added, if appropriate.

In a further embodiment, individual components of the agrochemical composition according to the invention, may be mixed by the user in a spray tank and further auxiliaries may be added, if appropriate.

In other embodiments, the adjuvant can be incorporated into the herbicide formulation (e.g., a pre-mix) as a component of a single commercial formulation.

The compounds can be delivered with water or as a neat liquid, solid or solution. The compounds may be sprayed into or onto soil at the time of planting, sprayed into or onto soil at intervals post emergence, or sprayed on the foliage of a plant. In addition, the compounds may be applied to seeds prior to planting using established methods. For example, they may be coated on seeds with an inert vehicle, tumbled, and dried.

The compounds can be applied to soil, or plants at any acceptable rate. For example, the compounds can be applied at a rate of at least about 0.0001 kg per acre, at least about 0.001 kg per acre, at least about 0.01 kg per acre, at least about 0.1 kg per acre, at least 0.5 kg per acre, at least 1 kg per acre, at least about 2 kg per acre, at least about 5 kg per acre, at least about 10 kg per acre, or at least about 20 kg per acre, although lower or higher application rates are not excluded.

In certain embodiments, the subject compositions can be stored at about 1° C. to about 37° C. or about 5° C. to about 25° C. In preferred embodiments, the plants or fungi are treated and grown at a temperature between about 5° C. to about 25° C. In other embodiments, the plants or fungi can be grown and treated at a temperature of about −10° C. to about 45° C.

The mode of application depends upon the formulation of the composition, and can include, for example, spraying, pouring, sprinkling, injecting, spreading, mixing, dunking, fogging, dripping, and misting. Formulations can include, for example, liquids, dry and/or wettable powders, soluble powders, flowable powders, dry flowables, emulsifiable concentrates, ultra-low-volume concentrates, dusts, granules (e.g., water dispersible granules), pellets, emulsions, microcapsules, nanocapsules, gels, pastes and/or aerosols. In an exemplary embodiment, the composition is applied after the composition has been prepared by, for example, mixing the composition with water.

All plants and plant parts can be treated in accordance with the subject invention. Plant parts or tissues are understood as meaning all aerial and subterranean parts and organs of the plants, such as a shoot, leaf, flower and root, examples which may be mentioned being leaves, needles, stalks, stems, flowers, buds, fruit bodies, fruits and seeds, but also roots, tubers and rhizomes. The plant parts also include crop material and vegetative and generative propagation material, for example cuttings, tubers, rhizomes, slips and seeds.

In one embodiment, the site to which the composition is applied is the soil in which plants will be planted or are growing (e.g., a field, an orchard, a grove, a pasture/prairie or a forest). The compositions of the subject invention can be pre-mixed with irrigation fluids, such that the compositions percolate through the soil and can be delivered to, for example, the soil.

Alternatively, the compositions can be applied aerially. In one embodiment, the compositions are applied to soil surfaces, with or without water, where the beneficial effect of the soil application can be activated by rainfall, sprinkler, flood, or drip irrigation. The subject composition can be contacted to any plant tissue, such as, for example, the primary root, secondary root, stems, leaves, fruits, flowers, or seeds.

The methods and compositions of the subject invention can be used either alone or in combination with additional components, such as additional herbicides, fertilizers, pesticides and/or other soil amendments. Preferably, the additional components are non-toxic and environmentally-friendly. The exact materials and the quantities thereof can be determined by, for example, a grower or soil scientist having the benefit of the subject disclosure.

### Target Plants

The target plants can either be plants that are weeds, or plants to be protected from weeds and other unwanted vegetation, or they can be crop plants that derive an agriculture benefit from treatment with a composition of the subject invention. This agriculture benefit can be, for example, desiccation, defoliation or improved harvesting of fruit or nuts.

In certain embodiments, the compositions and/or methods of the subject invention are used during a growing season. In these embodiments, the compositions and methods can first be determined to have no, or an acceptably low, deleterious impact on the desired plant(s).

Alternatively, or additionally, the compositions and methods can be applied in a targeted manner to avoid or reduce exposure of the desired plants to the compositions and methods.

Examples of plants for which the subject invention is useful include, but are not limited to, cereals and grasses (e.g., wheat, barley, rye, oat, rice, maize, sorghum, corn, millet, triticale, turf, pasture grass), beets (e.g., sugar or fodder beets); fruit (e.g., grapes, strawberries, raspberries, blackberries, pomaceous fruit, stone fruit, soft fruit, apples, pears, plums, peaches, almonds, cherries or berries); leguminous crops (e.g., beans, lentils, peas or soya); oil crops (e.g., oilseed rape, mustard, poppies, olives, sunflowers, coconut, castor, cocoa or ground nuts); cucurbits (e.g., pumpkins, cucumbers, squash or melons); fiber plants (e.g., cotton, flax, hemp or jute); citrus fruit (e.g., oranges, lemons, grapefruit or tangerines); vegetables (e.g., spinach, lettuce, asparagus, cabbages, broccolis, carrots, onions, tomatoes, potatoes or bell peppers); Lauraceae (e.g., avocado, Cinnamonium or camphor); and also tobacco, nuts, herbs, spices, medicinal plants, coffee, eggplants, sugarcane, tea, pepper, grapevines, hops, the plantain family, latex plants, cut flowers and ornamentals.

Further types of plants that can benefit from application of the products and methods of the subject invention include, but are not limited to: row crops (e.g., corn, soy, sorghum, peanuts, potatoes, etc.), field crops (e.g., alfalfa, wheat, grains, etc.), tree crops (e.g., walnuts, almonds, pecans, hazelnuts, pistachios, etc.), citrus crops (e.g., orange, lemon, grapefruit, etc.), fruit crops (e.g., apples, pears, strawberries, blueberries, blackberries, etc.), turf crops (e.g., sod), ornamentals crops (e.g., flowers, vines, etc.), vegetables (e.g., tomatoes, carrots, etc.), vine crops (e.g., grapes, etc.), forestry (e.g., pine, spruce, eucalyptus, poplar, etc.), managed pastures (any mix of plants used to support grazing animals).

Further plants that can benefit from the products and methods of the invention include all plants that belong to the superfamily Viridiplantae, in particular monocotyledonous and dicotyledonous plants including fodder or forage legumes, ornamental plants, food crops, trees or shrubs selected from Acer spp., Actinidia spp., Abelmoschus spp., Agave sisalana, Agropyron spp., Agrostis stolonifera, Allium spp., Amaranthus spp., Ammophila arenaria, Ananas comosus, Annona spp., Apium graveolens, Arachis spp, Artocarpus spp., Asparagus officinalis, Avena spp. (e.g., A. sativa, A. fatua, A. byzantina, A. fatua var. sativa, A. hybrida), Averrhoa carambola, Bambusa sp., Benincasa hispida, Bertholletia excelsea, Beta vulgaris, Brassica spp. (e.g., B. napus, B. rapa ssp. [canola, oilseed rape, turnip rape]), Cadaba farinosa, Camellia sinensis, Cannabis indica, Cannabis sativa, Cannabis ruderalis, Capsicum spp., Carex elata, Carica papaya, Carissa macrocarpa, Carya spp., Carthamus tinctorius, Castanea spp., Ceiba pentandra, Cichorium endivia, Cinnamomum spp., Citrullus lanatus, Citrus spp., Cocos spp., Coffea spp., Colocasia esculenta, Cola spp., Corchorus sp., Coriandrum sativum, Corylus spp., Crataegus spp., Crocus sativus, Cucurbita spp., Cucumis spp., Cynara spp., Daucus carota, Desmodium spp., Dimocarpus longan, Dioscorea spp., Diospyros spp., Echinochloa spp., Elaeis (e.g., E. guineensis, E. oleifera), Eleusine coracana, Eragrostis tef, Erianthus sp., Eriobotrya japonica, Eucalyptus sp., Eugenia unflora, Fagopyrum spp., Fagus spp., Festuca arundinacea, Ficus carica, Fortunella spp., Fragaria spp., Ginkgo biloba, Glycine spp. (e.g., G. max, Soja hispida or Soja max), Gossypium hirsutum, Helianthus spp. (e.g., H. annuus), Hemerocallis fulva, Hibiscus spp., Hordeum spp. (e.g., H. vulgare), Ipomoea batatas, Juglans spp., Lactuca sativa, Lathyrus spp., Lens culinaris, Linum usitatissimum, Litchi chinensis, Lotus spp., Luffa acutangula, Lupinus spp., Luzula sylvatica, Lycopersicon spp. (e.g., L. esculentum, L. lycopersicum, L. pyriforme), Macrotyloma spp., Malus spp., Malpighia emarginata, Mammea americana, Mangifera indica, Manihot spp., Manilkara zapota, Medicago sativa, Melilotus spp., Mentha spp., Miscanthus sinensis, Momordica spp., Morus nigra, Musa spp., Nicotiana spp., Olea spp., Opuntia spp., Ornithopus spp., Oryza spp. (e.g., O. sativa, O. latifolia), Panicum miliaceum, Panicum virgatum, Passiflora edulis, Pastinaca sativa, Pennisetum sp., Persea spp., Petroselinum crispum, Phalaris arundinacea, Phaseolus spp., Phleum pratense, Phoenix spp., Phragmites australis, Physalis spp., Pinus spp., Pistacia vera, Pisum spp., Poa spp., Populus spp., Prosopis spp., Prunus spp., Psidium spp., Punica granatum, Pyrus communis, Quercus spp., Raphanus sativus, Rheum rhabarbarum, Ribes spp., Ricinus communis, Rubus spp., Saccharum spp., Salix sp., Sambucus spp., Secale cereale, Sesamum spp., Sinapis sp., Solanum spp. (e.g., S. tuberosum, S. integrifolium or S. lycopersicum), Sorghum bicolor, Spinacia spp., Syzygium spp., Tagetes spp., Tamarindus indica, Theobroma cacao, Trifolium spp., Tripsacum dactyloides, Triticosecale rimpaui, Triticum spp. (e.g., T. aestivum, T durum, T. turgidum, T hybernum, T. macha, T. sativum, T monococcum or T. vulgare), Tropaeolum minus, Tropaeolum majus, Vaccinium spp., Vicia spp., Vigna spp., Viola odorata, Vitis spp., Zea mays, Zizania palustris, Ziziphus spp., amongst others.

Further examples of plants of interest include, but are not limited to, corn (Zea mays), Brassica sp. (e.g., B. napus, B. rapa, B. juncea), particularly those Brassica species useful as sources of seed oil, alfalfa (Medicago sativa), rice (Oryza sativa), rye (Secale cereale), sorghum (Sorghum bicolor, Sorghum vulgare), millet (e.g., pearl millet (Pennisetum glaucum), proso millet (Panicum miliaceum), foxtail millet (Setaria italica), finger millet (Eleusine coracana)), sunflower (Helianthus annuus), safflower (Carthamus tinctorius), wheat (Triticum aestivum), soybean (Glycine max), tobacco (Nicotiana tabacum), potato (Solanum tuberosum), peanuts (Arachis hypogaea), cotton (Gossypium barbadense, Gossypium hirsutum), sweet potato (Ipomoea batatus), cassava (Manihot esculenta), coffee (Coffea spp.), coconut (Cocos nucifera), pineapple (Ananas comosus), citrus trees (Citrus spp.), cocoa (Theobroma cacao), tea (Camellia sinensis), banana (Musa spp.), avocado (Persea americana), fig (Ficus casica), guava (Psidium guajava), mango (Mangifera indica), olive (Olea europaea), papaya (Carica papaya), cashew (Anacardium occidentale), macadamia (Macadamia integrifolia), almond (Prunus amygdalus), sugar beets (Beta vulgaris), sugarcane (Saccharum spp.), oats, barley, vegetables, ornamentals, and conifers.

Vegetables include tomatoes (Lycopersicon esculentum), lettuce (e.g., Lactuca sativa), green beans (Phaseolus vulgaris), lima beans (Phaseolus limensis), peas (Lathyrus spp.), and members of the genus Cucumis such as cucumber (C. sativus), cantaloupe (C. cantalupensis), and musk melon (C. melo). Ornamentals include azalea (Rhododendron spp.), hydrangea (Macrophylla hydrangea), hibiscus (Hibiscus rosasanensis), roses (Rosa spp.), tulips (Tulipa spp.), daffodils (Narcissus spp.), petunias (Petunia hybrida), carnation (Dianthus caryophyllus), poinsettia (Euphorbia pulcherrima), and chrysanthemum. Conifers that may be employed in practicing the embodiments include, for example, pines such as loblolly pine (Pinus taeda), slash pine (Pinus elliotii), ponderosa pine (Pinus ponderosa), lodgepole pine (Pinus contorta), and Monterey pine (Pinus radiata); Douglas-fir (Pseudotsuga menziesii); Western hemlock (Tsuga canadensis); Sitka spruce (Picea glauca); redwood (Sequoia sempervirens); true firs such as silver fir (Abies amabilis) and balsam fir (Abies balsamea); and cedars such as Western red cedar (Thuja plicata) and Alaska yellow-cedar (Chamaecyparis nootkatensis). Plants of the embodiments include crop plants (for example, corn, alfalfa, sunflower, Brassica, soybean, cotton, safflower, peanut, sorghum, wheat, millet, tobacco, etc.), such as corn and soybean plants.

Turfgrasses include, but are not limited to: annual bluegrass (Poa annua); annual ryegrass (Lolium multiflorum); Canada bluegrass (Poa compressa); Chewings fescue (Festuca rubra); colonial bentgrass (Agrostis tenuis); creeping bentgrass (Agrostis palustris); crested wheatgrass (Agropyron desertorum); fairway wheatgrass (Agropyron cristatum); hard fescue (Festuca longifolia); Kentucky bluegrass (Poa pratensis); orchardgrass (Dactylis glomerate); perennial ryegrass (Lolium perenne); red fescue (Festuca rubra); redtop (Agrostis alba); rough bluegrass (Poa trivialis); sheep fescue (Festuca ovine); smooth bromegrass (Bromus inermis); tall fescue (Festuca arundinacea); timothy (Phleum pretense); velvet bentgrass (Agrostis canine); weeping alkaligrass (Puccinellia distans); western wheatgrass (Agropyron smithii); Bermuda grass (Cynodon spp.); St. Augustine grass (Stenotaphrum secundatum); zoysia grass (Zoysia spp.); Bahia grass (Paspalum notatum); carpet grass (Axonopus affinis); centipede grass (Eremochloa ophiuroides); kikuyu grass (Pennisetum clandesinum); seashore paspalum (Paspalum vaginatum); blue gramma (Bouteloua gracilis); buffalo grass (Buchloe dactyloids); sideoats gramma (Bouteloua curtipendula).

Plants of interest include grain plants that provide seeds of interest, oil-seed plants, and leguminous plants. Seeds of interest include grain seeds, such as corn, wheat, barley, rice, sorghum, rye, millet, etc. Oil-seed plants include cotton, soybean, safflower, sunflower, Brassica, maize, alfalfa, palm, coconut, flax, castor, olive etc. Leguminous plants include beans and peas. Beans include guar, locust bean, fenugreek, soybean, garden beans, cowpea, mungbean, lima bean, fava bean, lentils, chickpea, etc.

Further plants of interest include Cannabis (e.g., sativa, indica, and ruderalis) and industrial hemp.

### Herbicides

In specific embodiments, the adjuvants of the subject invention can be used to improve the efficacy of herbicides including, but not limited to, glyphosate, Atrazine, 2,4-D (2,4-Dichlorophenoxyacetic acid), Dicamba, Glufosinate-Ammonium, Paraquat, sethoxydim, ALS inhibitors, MCPA, flutenacet, ACCase inhibitors, Metolachlor, Imazapyr, Pendimethalin, and Trifluralin so that they are effective at lower concentrations and/or on herbicide resistant plants. In certain embodiments, the adjuvants serve as synergists for herbicides, where the adjuvant itself has herbicidal activity, which, when applied with certain herbicides, results in a synergistic herbicidal effect.

Herbicides that are useful according to the invention include but are not limited to: Acetochlor, acifluorfen, acifluorfen-sodium, aclonifen, alachlor, allidochlor, alloxydim, alloxydim-sodium, ametryn, amicarbazone, amidochlor, amidosulfuron, 4-amino-3-chloro-5-fluoro-6-(7-fluoro-1H-indol-6-yl)pyridine-2-carboxylic acid, aminocyclopyrachlor, aminocyclopyrachlor-potassium, aminocyclopyrachlor-methyl, aminopyralid, amitrole, ammoniumsulfamate, anilofos, asulam, atrazine, azafenidin, azimsulfuron, beflubutamid, benazolin, benazolin-ethyl, benfluralin, benfuresate, bensulfuron, bensulfuron-methyl, bensulide, bentazone, benzobicyclon, benzofenap, bicyclopyron, bifenox, bilanafos, bilanafos-sodium, bispyribac, bispyribac-sodium, bixlozone, bromacil, bromobutide, bromofenoxim, bromoxynil, bromoxynil-butyrate, -potassium, -heptanoate, and -octanoate, busoxinone, butachlor, butafenacil, butamifos, butenachlor, butralin, butroxydim, butylate, cafenstrole, carbetamide, carfentrazone, carfentrazone-ethyl, chloramben, chlorbromuron, 1-{2-chloro-3-[(3-cyclopropyl-5-hydroxy-1-methyl-1H-pyrazol-4-yl)carbonyl]-6-(trifluormethyl)phenyl}piperidin-2-on, 4-{2-chloro-3-[(3,5-dimethyl-1H-pyrazol-1-yl)methyl]-4-(methylsulfonyl)benzoyl}-1,3-dimethyl-1H-pyrazol-5-yl-1,3-dimethyl-1H-pyrazol-4-carboxylat, chlorfenac, chlorfenac-sodium, chlorfenprop, chlorflurenol, chlorflurenol-methyl, chloridazon, chlorimuron, chlorimuron-ethyl, 2-[2-chloro-4-(methylsulfonyl)-3-(morpholin-4-ylmethyl)benzoyl]-3-hydroxycyclohex-2-en-1-on, 4-{2-chloro-4-(methylsulfonyl)-3-[(2,2,2-trifluorethoxy)methyl]benzoyl}-1-ethyl-1H-pyrazol-5-yl-1,3-dimethyl-1H-pyrazol-4-carboxylat, chlorophthalim, chlorotoluron, chlorthal-dimethyl, 3-[5-chloro-4-(trifluormethyl)pyridine-2-yl]-4-hydroxy-1-methylimidazolidine-2-on, chlorsulfuron, cinidon, cinidon-ethyl, cinmethylin, cinosulfuron, clacyfos, clethodim, clodinafop, clodinafop-propargyl, clomazone, clomeprop, clopyralid, cloransulam, cloransulam-methyl, cumyluron, cyanamide, cyanazine, cycloate, cyclopyranil, cyclopyrimorate, cyclosulfamuron, cycloxydim, cyhalofop, cyhalofop-butyl, cyprazine, 2,4-D, 2,4-D-butotyl, -butyl, - dimethylammonium, -diolamin, -ethyl, -2-ethylhexyl, -isobutyl, -isooctyl, -isopropylammonium, - potassium, -triisopropanolammonium, and -trolamine, 2,4-DB, 2,4-DB-butyl, -dimethylammonium, - isooctyl, -potassium, and -sodium, daimuron (dymron), dalapon, dazomet, n-decanol, desmedipham, detosyl-pyrazolate (DTP), dicamba, dichlobenil, dichlorprop, dichlorprop-P, diclofop, diclofop-methyl, diclofop-P-methyl, diclosulam, difenzoquat, diflufenican, diflufenzopyr, diflufenzopyr-sodium, dimefuron, dimepiperate, dimethachlor, dimethametryn, dimethenamid, dimethenamid-P, 3-(2,6-dimethylphenyl)-6-[(2-hydroxy-6-oxocyclohex-1-en-1-yl)carbonyl]- 1-methylchinazolin-2,4(1H,3H)-dion, 1,3-dimethyl-4-[2-(methylsulfonyl)-4-(trifluormethyl)benzoyl]-1H-pyrazol-5-yl-1,3-dimethyl-1H-pyrazol-4-carboxylat, dimetrasulfuron, dinitramine, dinoterb, diphenamid, diquat, diquat-dibromid, dithiopyr, diuron, DMPA, DNOC, endothal, EPTC, esprocarb, ethalfluralin, ethametsulfuron, ethametsulfuron-methyl, ethiozin, ethofumesate, ethoxyfen, ethoxyfen-ethyl, ethoxysulfuron, etobenzanid, ethyl-[(3-{2-chloro-4-fluoro-5-[3-methyl-2,6-dioxo-4-(trifluormethyl)-3,6- dihydropyrimidin-1(2H)-yl]phenoxy}pyridin-2-yl)oxy]acetat, F-9960, F-5231, i.e., N-{2-chloro-4- fluoro-5-[4-(3-fluoropropyl)-5-oxo-4,5-dihydro-1H-tetrazol-1-yl]phenyl}ethanesulfonamide, F-7967, i.e., 3-[7-chloro-5-fluoro-2-(trifluoromethyl)-1H-benzimidazol-4-yl]-1-methyl-6-(trifluoromethyl)pyrimidine-2,4(1H,3H)-dione, fenoxaprop, fenoxaprop-P, fenoxaprop-ethyl, fenoxaprop-P-ethyl, fenoxasulfone, fenquinotrione, fentrazamide, flamprop, flamprop-M-isopropyl, flamprop-M-methyl, flazasulfuron, florasulam, fluazifop, fluazifop-P, fluazifop-butyl, fluazifop-P-butyl, flucarbazone, flucarbazone-sodium, flucetosulfuron, fluchloralin, flufenacet, flufenpyr, flufenpyr-ethyl, flumetsulam, flumiclorac, flumiclorac-pentyl, flumioxazin, fluometuron, flurenol, flurenol-butyl, -dimethylammonium and -methyl, fluoroglycofen, fluoroglycofen-ethyl, flupropanate, flupyrsulfuron, flupyrsulfuron-methyl-sodium, fluridone, fluro-chloridone, fluroxypyr, fluroxypyr- meptyl, flurtamone, fluthiacet, fluthiacet-methyl, fomesafen, fomesafen-sodium, foramsulfuron, fosamine, glufosinate, glufosinate-ammonium, glufosinate-P-sodium, glufosinate-P-ammonium, glufosinate-P-sodium, glyphosate, glyphosate-ammonium, -isopropylammonium, -diammonium, - dimethylammonium, -potassium, -sodium, and -trimesium, H-9201, i.e., O-(2,4-dimethyl-6-nitrophenyl)O-ethyl isopropylphosphoramidothioate, halauxifen, halauxifen-methyl,halosafen, halosulfuron, halosulfuron-methyl, haloxyfop, haloxyfop-P, haloxyfop-ethoxyethyl, haloxyfop-P-ethoxyethyl, haloxyfop-methyl, haloxyfop-P-methyl, hexazinone, HW-02, i.e., 1-(dimethoxyphosphoryl) ethyl-(2,4-dichlorophenoxy)acetate, 4-hydroxy-1-methoxy-5-methyl-3-[4-(trifluormethyl)pyridine-2-yl]imidazolidine-2-on, 4-hydroxy-1-methyl-3-[4-(trifluormethyl)pyridine-2-yl]imidazolidine-2-on, (5-hydroxy-1-methyl-1H-pyrazol-4-yl)(3,3,4-trimethyl-1,1-dioxido-2, 3-dihydro-1-benzothiophen-5-yl)methanon, 6-[(2-hydroxy-6-oxocyclohex- 1-en-1-yl)carbonyl]-1,5-dimethyl-3-(2-methylphenyl)chinazolin-2,4(1H,3H)-dion, imazamethabenz, imazamethabenz-methyl, imazamox, imazamox-ammonium, imazapic, imazapic-ammonium, imazapyr, imazapyr-isopropylammonium, imazaquin, imazaquin-ammonium, imazethapyr, imazethapyr-immonium, imazosulfuron, indanofan, indaziflam, iodosulfuron, iodosulfuron-methyl- sodium, ioxynil, ioxynil-octanoate, -potassium and -sodium, ipfencarbazone, isoproturon, isouron, isoxaben, isoxaflutole, karbutilate, KUH-043, i.e., 3-({[5-(difluoromethyl)-1-methyl-3-(trifluoromethyl)-1H-pyrazol-4-yl]methyl}sulfonyl)-5,5-dimethyl-4,5-dihydro-1,2-oxazole, keto- spiradox, lactofen, lenacil, linuron, MCPA, MCPA-butotyl, -dimethylammonium, -2-ethylhexyl, - isopropylammonium, -potassium, and -sodium, MCPB, MCPB-methyl, -ethy,l and -sodium, mecoprop, mecoprop-sodium, and -butotyl, mecoprop-P, mecoprop-P-butotyl, -dimethylammonium, -2- ethylhexyl, and -potassium, mefenacet, mefluidide, mesosulfuron, mesosulfuron-methyl, mesotrione, methabenzthiazuron, metam, metamifop, metamitron, metazachlor, metazosulfuron, methabenzthiazuron, methiopyrsulfuron, methiozolin, 2-({2-[(2-methoxyethoxy)methyl]-6-(trifluormethyl)pyridin-3-yl}carbonyl)cyclohexan-1,3-dion, methyl isothiocyanate, 1-methyl-4-[(3,3,4-trimethyl-l,l-dioxido-2,3-dihydro-1-benzothiophen-5-yl)carbonyl]-H-pyrazol-5-ylpropan-1-sulfonat, metobromuron, metolachlor, S-metolachlor, metosulam, metoxuron, metribuzin, metsulfuron, metsulfuron-methyl, molinat, monolinuron, monosulfuron, monosulfuron-ester, MT-5950, i.e., N-(3-chloro-4-isopropylphenyl)-2-methylpentan amide, NGGC-011, napropamide, NC-310, i.e., [5-(benzyloxy)-1-methyl-1H-pyrazol-4-yl](2,4-dichlorophenyl)-methanone, neburon, nicosulfuron, nonanoic acid (pelargonic acid), norflurazon, oleic acid (fatty acids), orbencarb, orthosulfamuron, oryzalin, oxadiargyl, oxadiazon, oxasulfuron, oxaziclomefon, oxyfluorfen, paraquat, paraquat dichloride, pebulate, pendimethalin, penoxsulam, pentachlorphenol, pentoxazone, pethoxamid, petroleum oils, phenmedipham, picloram, picolinafen, pinoxaden, piperophos, pretilachlor, primisulfuron, primisulfuron-methyl, prodiamine, profoxydim, prometon, prometryn, propachlor, propanil, propaquizafop, propazine, propham, propisochlor, propoxy-carbazone, propoxycarbazonesodium, propyrisulfuron, propyzamide, prosulfocarb, prosulfuron, pyraclonil, pyraflufen, pyraflufen- ethyl, pyrasulfotole, pyrazolynate (pyrazolate), pyrazosulfuron, pyrazosulfuron-ethyl, pyrazoxyfen, pyribambenz, pyribambenz-isopropyl, pyribambenz-propyl, pyribenzoxim, pyributicarb, pyridafol, pyridate, pyriftalid, pyriminobac, pyriminobac -methyl, pyrimi-sulfan, pyrithiobac, pyrithiobac-sodium, pyroxasulfone, pyroxsulam, quinclorac, quinmerac, quino-clamine, quizalofop, quizalofop-ethyl, quizalofop-P, quizalofop-P-ethyl, quizalofop-P-tefuryl, QYM-201, QYR-301, rimsulfuron, saflufenacil, sethoxydim, siduron, simazine, simetryn, SL-261, sulcotrion, sulfentrazone, sulfometuron, sulfometuron-methyl, sulfosulfuron, SYN-523, SYP-249, i.e., 1-ethoxy-3-methyl-1-oxobut-3-en-2-yl 5-[2-chloro-4-(trifluoromethyl)phenoxy]-2-nitrobenzoate, SYP-300, i.e., 1-[7-fluoro-3-oxo-4-(prop-2-yn-1-yl)-3,4-dihydro-2H-1,4-benzoxazin-6-yl]-3-propyl-2-thioxoimidazolidine-4, 5-dione, 2,3,6-TBA, TCA (trichloroacetic acid), TCA-sodium, tebuthiuron, tefuryltrione, tembotrione, tepraloxydim, terbacil, terbucarb, terbumeton, terbuthylazin, terbutryn, tetflupyrolimet, thenylchlor, thiazopyr, thiencarbazone, thiencarbazone-methyl, thifensulfuron, thifensulfuron-methyl, thiobencarb, tiafenacil, tolpyralate, topramezone, tralkoxydim, triafamone, tri-allate, triasulfuron, triaziflam, tribenuron, tribenuron-methyl, triclopyr, trietazine, trifloxysulfuron, trifloxysulfuron-sodium, trifludimoxazin, trifluralin, triflusulfuron, triflusulfuron-methyl, tritosulfuron, urea sulfate, vernolate, ZJ-0862, i.e., 3,4- dichloro-N-{2-[(4,6-dimethoxypyrimidin-2-yl)oxy]benzyl}aniline.

In specific embodiments, the adjuvants of the subject invention can be used to improve the efficacy of herbicides comprising an unsubstituted, or substituted, saturated, or unsaturated fatty acid, e.g., a C6-C20, or C8-C12 fatty acid, or a derivative thereof, so that they are effective at lower concentrations and/or on herbicide resistant plants. In certain embodiments, the adjuvants serve as synergists for the fatty acid and/or derivative thereof, where the adjuvant itself has herbicidal activity, which, when applied with the fatty acid and/or derivative thereof, results in a synergistic herbicidal effect.

The fatty acid can be, but is not limited to, e.g., pelargonic acid, capric acid, caprylic acid, oleic acid, undecanoic acid, lauric acid, linoleic acid, caproic acid, myristic acid, palmitic acid, stearic acid, oleic acid, arachidic acid, behenic acid, lignoceric acid, and/or cerotic acid. Derivatives of the fatty acids can include, e.g., fatty acid esters, fatty acid ethers, and/or fatty acid salts derived from the fatty acids.

In some embodiments, a blend of two or more fatty acids and/or fatty acid derivatives is utilized.

In one embodiment, the fatty acid is pelargonic acid, which may be used alone or as the major constituent (e.g., at least 50% to at least 90%) of a mixture that includes other fatty acids or derivatives thereof. In one exemplary embodiment, the fatty acid blend comprises a mixture of pelargonic acid, caprylic acid and capric acid, wherein pelargonic acid accounts for the majority of the mixture. An example of such a mixture, having about 94% pelargonic acid, 4% caprylic acid and 2% capric acid, is commercially available under the trademark “EMERY 1202” from Emery Division. Quantum Chemical Corporation, Cincinnati, Ohio. It is expected that the ratios of the various constituents of the fatty acids (and/or derivatives) and mixtures may be altered or that other combinations of fatty acids (and/or derivatives) having between 6 and 20 carbon atoms may be used to obtain the same or better results.

Advantageously, fatty acid herbicides are generally considered to be environmentally friendly. In some embodiments, the fatty acids are contact herbicides that have little or no residual soil activity and are rapidly degraded and used as a nutrient source by soil microorganisms. These compositions are also substantially non-toxic to humans and animals, and, in ready-to-use form, are not corrosive to the eyes and skin. The fatty acid(s) can also be used in conjunction with other herbicides, such as glyphosate, gamma-decalactone and gamma-indecalactone.

In certain embodiments, the fatty acid herbicides are supplied as concentrates that are diluted with water and applied as an oil-in-water emulsion. The concentrate may contain the fatty acid active ingredient(s) and emulsifying agents including, e.g., surfactants and/or oils.

In certain embodiments, the fatty acid herbicides are applied a concentration of 0.1% to 50%, 1% to 25%, 2.5% to 15%, or 5% to 10% by weight, after dilution.

All active ingredients as described above can be present in the form of the free compound or, if their functional groups enable this, an agrochemically active salt thereof.

### Target Weeds and Fungi

In certain embodiments, the subject composition can be applied to a weed or fungus, which is a wild plant growing where it is not wanted and typically in competition with cultivated plants.

In certain embodiments, the weed is Poison sumac (Toxicodendron vernix), Japanese knot weed (Polygonum cuspidatum), crabgrass (Digitaria spp.), dandelions (Taraxaum spp.), broadleaf plantain (Plantago major), common ragweed (Ambrosia artemisiifolia), giant ragweed (Abrosia trifida), bindweed (Convolvulus arvensis), ground ivy (Glechoma hederacea), purslane (Portulaca olearacea), stinging nettle (Urtica dioica), curly dock (Rumex crispus), bitter dock (Rumex obtusifolius), wild madder (Galium mollugo), clover leaf (Trifolium), orange jewelweed (Impatiens capensis), bittersweet (Celastrus spp.), horsetail weed (Equisetum arvense), chickweed (Stellaria media), Canada thistle (Cirsium arvense), annual sow thistle (Sonchus oleraceus), quackgrass (Elymus repens), Shepherd's Purse (Capsella bursa-pastoris), woodsorrel (Oxalis stricta), common mallow (Malva neglecta), lambsquarters (Chenopodium album), Palmer Amaranth (Amaranthus palmeri), pigweed (Amaranthus retroflexus), nutsedge (Cyperus spp.), dayflower (Commelina spp.), velvetleaf (Abutilon theophrasti), wild violet (Viola papilionacea), smartweed (Polygonum pensylvanicum), quickweed (Galinsoga parviflora), pokeweed (Phytolacca americana), black nightshade (Solanum nigrum), black medic (Medicago lupulina), poison ivy (Rhus radicans), burdock (Arctium spp.), common groundsel (Senecio vulgaris), curly dock (Rumex crispus), spurge (Euphorbia maculata), puncturevine (Tribulus terrestris), rough cinquefoil (Potentilla norvegica), sandbur (Cenchrus spp.), sheep sorrel (Rumex acetosella), Bermuda grass (Cynodon dactylon), common daisy (Bellis perennis L.), common self-heal (Prunella vulgaris L.), creeping buttercup (Ranunculus repens), doveweed (Murdannia nudiflora), flatweed (Hypochaeris radicata), ground elder (Aegopodium podagraria), herb bennet (Geum urbanum), foxtail (Setaria viridis, Setaria pumila). or marestail (Conyza canadensis).

As used herein, the term “fungi” or “fungus” generally includes, without limitation, mycelium, spawn, mushrooms, and similar terms. In certain embodiments, the fungus is Agaricus bisporus, Pleurotus spp., Morchella spp., Lentinula edodes, Auricularia heimuer, Volvariella volvacea, Volvariella bombycine, Flammulina filformis, Flammulina velutipes, Tremella fuciformis, Hypsizygus tessellatus, Stropharia rugosoannulata, Cyclocybe aegerita, Hericium erinaceus, Phallus indusiatus, Boletus edulis, Boletus griseus, Boletus variipes, Boletus pinophilus, Calbovista subsculpta, Calvatia gigantea, Cantharellus cibarius, Craterellus tubaeformis, Cranterellus fallax, Clitocybe nuda, Cortinarius caperatus, Craterellus cornucopioides, Grifola frondosa, Hericium erinaceus, Hydnum repandum, Lactarius deliciosus, Morchella spp. (e.g., Morchella conica var. deliciosa, Morchella esculenta var. rotunda, Morchella crassipes, Morchella elata), Pleurotus spp., Pleurotus ostreatus, Termitomyces spp. (e.g., Termitomyces titanicus), Tricholoma matsutake, Tuber spp. (e.g., Tuber aestivum, Tuber borchii, Tuber brumale, Tuber indicum, Tuber macrosporum, Tuber mesentericum), Agaricus arvensis, Agaricus silvaticus, Agaricus solidipes, Agaricus campestris, Agaricus prophyrocephalus, Aleuria aurantia, Amanita caesarea, Armillaria mellea, Boletus badius, Bovistella radicata, Calocybe gambosa, Calvatia utriformis, Calvatia cyanthiformis, Chroogomphus spp., Clavariaceae spp., Clavulinaceae spp., Coprinus comatus, Corn smut, Cortinarius variicolor, Cyttaria espinosae, Fistulina hepatica, Flammulina velutipes, Hygrophorus chrysodon, Kalaharituber pfeilii, Auricularia auricula-judae, Lactarius deterrimus, Lactarius salmonicolor, Lactarius subdulcis, Lactarius volemus, Laetiporus sulphureus, Leccinum aurantiacum, Leccinum scabrum, Leccinum versipelle, Macrolepiota procera, Marasmius oreades, Polyporus mylittae, Polyporus squamosus, Pseudohydnum gelatinosum, Ramariaceae spp., Rhizopogon luteolus, Russula spp. (e.g., R. laeta), Sparassis crispa, Suillus bovinus, Suillus granulatus, Suillus luteus, Suillus tomentosus, Suillus brevipes, Suillus pictus, Suillus decipiens, Tricholoma terreum, Amanita muscaria, Amanita rubescens, Coprinopsis atramentaria, Gyromitra esculenta, Lactarius spp. (e.g., Lactarius deliciosus, Lactarius indigo, Lactarius paradoxus, Lactarius corrugis, Lactarius volemus, Lactarius hygrophoroides), Lepista saeva, Morchella esculenta, or Verpa bohemica.

### Auxiliary Technologies

The methods and compositions of the subject invention may be applied in combination with, or by utilizing, additional agricultural technologies, such as precision agriculture, remote and proximate imaging and image recognition, and agricultural site management programs. These technologies typically include models, e.g., computer programs, that support the user by considering information from a wide variety of sources to increase the quality and yield of harvested material, reduce damage by pests including the prediction of pest pressure and smart application of crop protection products, identify weed escapes to allow GPS guided spraying to control them, secure environmental protection, support quick and reliable agronomic decision making, reduce usage of fertilizers and crop protection products, reduce product residues in consumables increase spatial and temporal precision of agronomical measures, automate processes, and enable traceability of measures.

Information input for these models can include, but is not limited to, soil data (e.g., pH, organic matter content, moisture level, nutrient content such as nitrogen, potassium, phosphorous and micro-nutrient content); information on the plants that are currently growing or that may grow at the area of interest including crop plants and/or weeds (e.g. type of plant, chlorophyl levels, biomass, growth stage, plant health, plant water status, plant growth models, genetic traits, biotic damage by infestation or infection with pests, abiotic damage as caused by drought or nutrient stress etc.); weather information (e.g., information on past and present, and forecast of future temperature, humidity, and/or precipitation); information on the location of the area and directly derivable information thereof (e.g., terrain features like altitude, slope, water bodies, sun exposure and hours of sunshine per day, vegetation period, etc.); information on pest pressure (e.g., information of the past or present occurrence of unwanted vegetation, fungal diseases and invertebrate pests at the area of interest, at neighboring areas, the region, or the vegetation zone); information on beneficial organisms (e.g., information of the past or present occurrence of beneficial organisms at the area of interest, at neighboring areas, the region, or the vegetation zone); and/or historic information of any of the aforementioned (e.g., information on previous seasons, or of an earlier point in time of the same season).

Data sources typically include proximate-detection systems such as soil-borne sensors and remote sensing as may be achieved by imaging with, for example, unmanned airborne vehicles such as drones, or satellites. Imaging technologies include poly- and multispectral imagery in the UV-VIS, NIR and UV spectrums. Sensors may be directly or indirectly connected to a processing unit, e.g., via a wireless network and/or cloud applications. The information is typically taken into account by at least one processing unit and used to provide recommendations, generate control signals (e.g., for the control of agricultural machinery such as tractors, drones, irrigation systems, farm management systems and the like), and/or generate maps on the area of interest. These maps contain spatially and, optionally, temporally resolved information of the agricultural site, wherein the information may contain information directly gathered as described above, combinations thereof or derived therefrom, such as pest pressure, weed escapes, nutrient levels, and the like. The recommendations, control signals and maps may relate to, or be used for, controlling the application of water, nutrients, agrochemical products, or plant propagation material to the field of interest, or for taking other management measures such as tilling, physical, spot spraying or laser-induced weeding.

Technologies that can be used include self-steering machinery (such as tractors, harvesters, drones), artificial intelligence (e.g., machine learning), imaging technologies (e.g., image segmentation technologies), big data analysis, model generation, cloud computing, and machine-to-machine communication.

In preferred embodiments, the farming system utilizes spatially and/or temporally resolved, targeted application of active ingredients such as pesticides, plant-growth-regulators, fertilizers, and/or water including the variation of application rates over the agronomic site, zone or spot application, and of the spatially and/or temporally resolved, targeted planting or seeding of desired plant material to an agronomic site.

Geo-positioning technologies such as GPS can be used to gain information on the location and boundaries of an area of interest, the application equipment, sensing equipment and recorded data, and to control the actions of farm vehicles such as those used for spraying. By combining geo-positioning data with digital maps, it is possible to automate agricultural measures at the site of interest, e.g., by using autonomous spraying equipment.

Additional features can include the application of smart spraying equipment, e.g., spot spraying, and precision spraying at a farm, e.g., by irrigation systems, tractors, robots, helicopters, airplanes, and unmanned aerial vehicles, such as drones. Such equipment usually includes input sensors (such as a camera) and a processing unit configured to analyze the input data and to provide a recommendation or decision based on the analysis of the input data to apply the compositions of the invention to the site.

For example, weeds may be detected, identified, and/or classified from imagery acquired by a camera. Such identification and/classification can make use of image processing algorithms, which can utilize artificial intelligence (e.g., machine learning algorithms), or decision trees. In this manner, the methods and compositions described herein can be applied only at the required location, point in time and dose rate.

### Compositions

The subject invention provides, in preferred embodiments, agriculturally-advantageous, such as herbicidally-effective, compositions comprising an active agriculture compound, such as a herbicide, and an adjuvant of the subject invention. Typically, the composition further comprises at least one liquid and/or solid carrier and/or one or more surfactants and, if desired, one or more further auxiliaries, such as safeners, customary for agrochemical compositions.

In some embodiments, the concentration at which the adjuvant composition is employed imparts no or minimal herbicidal activity itself, while in other embodiments, the adjuvant composition is employed at a concentration such that the adjuvant composition has some level of activity but that level is less than what is achieved when used in combination with the herbicide. The adjuvant alone may have, for example, a level of activity that does not achieve commercial control.

The adjuvant composition, agricultural chemical, and/or an agricultural composition formed by the two of these combined, can be formulated as suspension concentrates, aqueous suspensions, suspo-emulsions or capsule suspensions, emulsion concentrates, water dispersible granules, oil dispersions, emulsifiable concentrates, dispersible concentrates, wettable granules, wherein in the case of non-aqueous formulations or solid formulations a sprayable formulation can be obtained by adding a liquid carrier such as water.

In certain embodiments, the agricultural composition can comprise additional substances, such as, for example, water, carriers, pH adjusters, microbial inoculants, mineral sources, plant seeds, dyes, stabilizers, emulsifiers, prebiotics, polymers, buffering agents, viscosity modifiers, preservatives, nutrients for plant and/or beneficial microbe growth, tracking agents, biocides, surfactants, lubricants, solubility controlling agents, preservatives, and ultra-violet light resistant agents.

The pH of the composition should be suitable for the components of interest as well as for the plant and/or soil environment to which it will be applied. In some embodiments, the pH is about 2.0 to about 10.0, about 2.0 to about 9.5, about 2.0 to about 9.0, about 2.0 to about 8.5, about 2.0 to about 8.0, about 2.0 to about 7.5, about 2.0 to about 7.0, about 3.0 to about 7.5, about 4.0 to about 7.5, about 5.0 to about 7.5, about 5.5 to about 7.0, about 6.5 to about 7.5, about 3.0 to about 5.5, about 3.25 to about 4.0, or about 3.5. In certain embodiments, the pH is less than 6.0, e.g., about 2.0 to about 5.5. In certain other embodiments, the pH is greater than 6.0, e.g., about 8.5 to 12.0. Buffers, and pH regulators, such as carbonates and phosphates, may be used to stabilize pH near a preferred value.

In certain embodiments, carriers used according to the subject invention are those which can customarily be used for this purpose in agrochemical formulations. A carrier is a solid or liquid, natural or synthetic, organic or inorganic substance that is generally inert, and which may be used as a solvent. The carrier generally improves the application of the compounds, for instance, to plants, plants parts or seeds. Examples of suitable solid carriers include, but are not limited to, ammonium salts, in particular ammonium sulfates, ammonium phosphates and ammonium nitrates, natural rock flours, such as kaolins, clays, talc, chalk, quartz, attapulgite, montmorillonite and diatomaceous earth, silica gel and synthetic rock flours, such as finely divided silica, alumina and silicates. Examples of typically useful solid carriers for preparing granules include, but are not limited to crushed and fractionated natural rocks such as calcite, marble, pumice, sepiolite and dolomite, synthetic granules of inorganic and organic flours and granules of organic material such as paper, sawdust, coconut shells, maize cobs and tobacco stalks. Preferred solid carriers are selected from clays, talc and silica.

Examples of suitable liquid carriers include, but are not limited to, water, organic solvents and combinations thereof. Examples of suitable solvents include polar and nonpolar organic chemical liquids, for example from the classes of alcohols and polyols (which may optionally also be substituted, etherified and/or esterified, such as ethanol, propanol, butanol, benzylalcohol, cyclohexanol or glycol, 2-ethyl hexanol), ethers such as dioctyl ether, tetrahydrofuran, dimethyl isosorbide, solketal, cyclopentyl methyl ether, solvents offered by Dow under the Dowanol Product Range e.g., Dowanol DPM, anisole, phenetole, different molecular weight grades of dimethyl polyethylene glycol, different molecular weight grades of dimethyl polypropylene glycol, dibenzyl ether ketones (such as acetone, methyl ethyl ketone, methyl isobutyl ketone, cyclopentanone, cyclohexanone, cycloheptanone, acetophenone, propiophenone), lactate esters, such as methyl lactate, ethyl lactate, propyl lactate, butyl lactate, 2-ethyl hexyl lactate (poly)ethers such as different molecular weight grades of polyethylene glycol, different molecular weight grades of polypropylene glycol unsubstituted and substituted amines amides (such as dimethylformamide, or N,N-dimethyl lactamide, or N-formyl morpholine, or fatty acid amides suchN,N-dimethyl decanamide or N,N-dimethyl dec-9-en-amide) and esters thereof lactams (such as 2-pyrrolidone, or N-alkylpyrrolidones, such as N-methylpyrrolidone, or N- butylpyrrolidone, or N-octylpyrrolidone, or N-dodecylpyrrolidone or N-methyl caprolactam, N- alkyl caprolactam) lactones (such as gamma-butyrolactone, gamma-valerolactone, delta-valerolactone, or alphamethyl gamma-butyrolactone sulfones and sulfoxides (such as dimethyl sulfoxide), nitriles, such as linear or cyclic alkyl nitriles, in particular acetonitrile, cyclohexane carbonitrile, octanonitrile, dodecanonitrile). linear and cyclic carbonates, such as diethyl carbonate, dipropyl carbonate, dibutyl carbonate, dioctyl carbonate, or ethylene carbonate, propylene carbonate, butylene carbonate, glycerine carbonate. In preferred embodiments, the carrier is water, including any available source of water, such as rivers, lakes, and groundwater, and can include, for example, any potable water, some non-potable waters, and recycled water, such as the water from run-off.

Suitable auxiliaries are solvents, liquid carriers, solid carriers or fillers, surfactants, dispersants, emulsifiers, wetters, adjuvants, solubilizers, penetration enhancers, protective colloids, adhesion agents, thickeners, humectants, repellents, attractants, feeding stimulants, compatibilizers, bactericides, anti-freezing agents, anti-foaming agents, colorants, tackifiers and binders.

Safeners are chemical compounds that prevent or reduce damage on useful plants without having a substantial impact on the herbicidal action of the herbicidal active components of the compositions towards unwanted plants. Safeners can be applied either before sowings (e.g., on seeds, shoots or seedlings) or in the pre-emergence application or post-emergence application of the crop.

The safeners and the herbicidal compositions can be applied jointly or separately.

Examples of safeners include benoxacor, cloquintocet, cyometrinil, cyprosulfamide, dichlormid, dicyclonon, dietholate, fenchlorazole, fenclorim, flurazole, fluxofenim, furilazole, isoxadifen, mefenpyr, mephenate, naphthalic anhydride, oxabetrinil, 4-(dichloroacetyl)-1-oxa-4-azaspiro[4.5]decane (MON4660, CAS 7152607-3), 2,2,5-trimethyl-3-(dichloroacetyl)-1,3-oxazolidine (R-29148, CAS 52836-31-4), metcamifen and BPCMS (CAS 54091 June 4).

In the agrochemical compositions of the subject invention, the active ingredients and optional further ingredients are present in suspended, emulsified or dissolved form. The agrochemical compositions can be in the form of aqueous solutions, powders, suspensions, also highly-concentrated aqueous, oily or other suspensions or dispersions, aqueous emulsions, aqueous microemulsions, aqueous suspo-emulsions, oil dispersions, pastes, dusts, materials for spreading or granules.

The agrochemical compositions can be prepared in a known manner.

Suitable solvents and liquid carriers are water and organic solvents, such as mineral oil fractions of medium to high boiling point, e.g., kerosene, diesel oil; oils of vegetable or animal origin; aliphatic, cyclic and aromatic hydrocarbons, e.g., toluene, paraffin, tetrahydronaphthalene, alkylated naphthalenes; alcohols, e.g., ethanol, propanol, butanol, benzylalcohol, cyclohexanol; glycols; DMSO; ketones, e.g., cyclohexanone; esters, e.g., lactates, carbonates, fatty acid esters, gamma-butyrolactone; fatty acids; phosphonates; amines; amides, e.g., N-methylpyrrolidone, fatty acid dimethylamides; and mixtures thereof.

Suitable solid carriers or fillers are mineral earths, e.g., silicates, silica gels, talc, kaolins, limestone, lime, chalk, clays, dolomite, diatomaceous earth, bentonite, calcium sulfate, magnesium sulfate, magnesium oxide; polysaccharides, e.g., cellulose, starch; fertilizers, e.g., ammonium sulfate, ammonium phosphate, ammonium nitrate, ureas; products of vegetable origin, e.g., cereal meal, tree bark meal, wood meal, nutshell meal, and mixtures thereof.

Suitable surfactants are surface-active compounds, such as anionic, cationic, nonionic and amphoteric surfactants, block polymers, polyelectrolytes, and mixtures thereof. Such surfactants can be used as emulsifier, dispersant, solubilizer, wetter, penetration enhancer, protective colloid, or adjuvant. Examples of surfactants are listed in Mccutcheon's, Vol. 1: Emulsifiers & Detergents, Mccutcheon's Directories, Glen Rock, USA, 2008 (International Ed. or North American Ed.).

Suitable anionic surfactants are alkali, alkaline earth or ammonium salts of sulfonates, sulfates, phosphates, carboxylates, and mixtures thereof. Examples of sulfonates are alkylarylsulfonates, diphenylsulfonates, alpha-olefin sulfonates, lignine sulfonates, sulfonates of fatty acids and oils, sulfonates of ethoxylated alkylphenols, sulfonates of alkoxylated arylphenols, sulfonates of condensed naphthalenes, sulfonates of dodecyl- and tridecylbenzenes, sulfonates of naphthalenes and alkylnaphthalenes, sulfosuccinates or sulfosuccinamates. Examples of sulfates are sulfates of fatty acids and oils, of ethoxylated alkylphenols, of alcohols, of ethoxylated alcohols, or of fatty acid esters. Examples of phosphates are phosphate esters. Examples of carboxylates are alkyl carboxylates, and carboxylated alcohol or alkylphenol ethoxylates.

Suitable nonionic surfactants are alkoxylates, N-substituted fatty acid amides, amine oxides, esters, sugar-based surfactants, polymeric surfactants, and mixtures thereof. Examples of alkoxylates are compounds such as alcohols, alkylphenols, amines, amides, arylphenols, fatty acids or fatty acid esters which have been alkoxylated with 1 to 50 equivalents. Ethylene oxide and/or propylene oxide may be employed for the alkoxylation, preferably ethylene oxide. Examples of N-substituted fatty acid amides are fatty acid glucamides or fatty acid alkanolamides. Examples of esters are fatty acid esters, glycerol esters or monoglycerides. Examples of sugar-based surfactants are sorbitans, ethoxylated sorbitans, sucrose and glucose esters or alkylpolyglucosides. Examples of polymeric surfactants are home- or copolymers of vinylpyrrolidone, vinylalcohols, or vinylacetate.

Suitable cationic surfactants are quaternary surfactants, for example quaternary ammonium compounds with one or two hydrophobic groups, or salts of long-chain primary amines. Suitable amphoteric surfactants are alkylbetains and imidazolines. Suitable block polymers are block polymers of the A-B or A-B-A type comprising blocks of polyethylene oxide and polypropylene oxide, or of the A-B—C type comprising alkanol, polyethylene oxide and polypropylene oxide. Suitable polyelectrolytes are polyacids or polybases. Examples of polyacids are alkali salts of polyacrylic acid or polyacid comb polymers. Examples of polybases are polyvinylamines or polyethyleneamines.

Suitable thickeners are polysaccharides (e.g., xanthan gum, carboxymethylcellulose), inorganic clays (organically modified or unmodified), polycarboxylates, and silicates.

Suitable bactericides are bronopol and isothiazolinone derivatives such as alkylisothiazolinones and benzisothiazolinones.

Suitable anti-freezing agents are ethylene glycol, propylene glycol, urea and glycerin.

Suitable anti-foaming agents are silicones, long chain alcohols, and salts of fatty acids.

Suitable colorants (e.g., in red, blue, or green) are pigments of low water solubility and water-soluble dyes. Examples are inorganic colorants (e.g., iron oxide, titan oxide, iron hexacyanoferrate) and organic colorants (e.g., alizarin-, azo- and phthalocyanine colorants).

Suitable tackifiers or binders are polyvinylpyrrolidons, polyvinylacetates, polyvinyl alcohols, polyacrylates, biological or synthetic waxes, and cellulose ethers.

Examples for agrochemical composition types and their preparation are:

### i) Water-Soluble Concentrates (SL, LS)

10-60 wt % of a composition according to the invention and 5-15 wt % wetting agent (e.g. alcohol alkoxylates) are dissolved in water and/or in a water-soluble solvent (e.g., alcohols) ad 100 wt %. The active substance dissolves upon dilution with water.

### ii) Dispersible Concentrates (DC)

5-25 wt % of a composition according to the invention and 1-10 wt % dispersant (e.g., polyvinylpyrrolidone) are dissolved in organic solvent (e.g., cyclohexanone) ad 100 wt %. Dilution with water gives a dispersion.

iii) Emulsifiable Concentrates (EC)

15-70 wt % of a composition according to the invention and 5-10 wt % emulsifiers (e.g., calcium dodecylbenzenesulfonate and castor oil ethoxylate) are dissolved in water-insoluble organic solvent (e.g., aromatic hydrocarbon) ad 100 wt %. Dilution with water gives an emulsion.

### iv) Emulsions (EW, EO, ES)

5-40 wt % of a composition according to the invention and 1-10 wt % emulsifiers (e.g., calcium dodecylbenzenesulfonate and castor oil ethoxylate) are dissolved in 20-40 wt % water-insoluble organic solvent (e.g., aromatic hydrocarbon). This mixture is introduced into water ad 100 wt % by means of an emulsifying machine and made into a homogeneous emulsion. Dilution with water gives an emulsion.

### v) Suspensions (SC, OD, FS)

In an agitated ball mill, 20-60 wt % of a composition according to the invention are comminuted with addition of 2-10 wt % dispersants and wetting agents (e.g., sodium lignosulfonate and alcohol ethoxylate), 0,1-2 wt % thickener (e.g., xanthan gum) and water ad 100 wt % to give a fine active substance suspension. Dilution with water gives a stable suspension of the active substance. For FS type composition up to 40 wt % binder (e.g., polyvinylalcohol) is added.

### vi) Water-Dispersible Granules and Water-Soluble Granules (WG, SG)

50-80 wt % of a composition according to the invention are ground finely with addition of dispersants and wetting agents (e.g., sodium lignosulfonate and alcohol ethoxylate) ad 100 wt % and prepared as water-dispersible or water-soluble granules by means of technical appliances (e.g., extrusion, spray tower, fluidized bed). Dilution with water gives a stable dispersion or solution of the active substance.

vii) Water-Dispersible Powders and Water-Soluble Powders (WP, SP, WS)

50-80 wt % of a composition according to the invention are ground in a rotor-stator mill with addition of 1-5 wt % dispersants (e.g., sodium lignosulfonate), 1-3 wt % wetting agents (e.g., alcohol ethoxylate) and solid carrier (e.g., silica gel) ad 100 wt %. Dilution with water gives a stable dispersion or solution of the active substance.

viii) Gel (GW, GF)

In an agitated ball mill, 5-25 wt % of a composition according to the invention are comminuted with addition of 3-10 wt % dispersants (e.g., sodium lignosulfonate), 1-5 wt % thickener (e.g., carboxymethylcellulose) and water ad 100 wt % to give a fine suspension of the active substance. Dilution with water gives a stable suspension of the active substance.

### ix) Microemulsion (ME)

5-20 wt % of a composition according to the invention are added to 5-30 wt % organic solvent blend (e.g., fatty acid dimethylamide and cyclohexanone), 10-25 wt % surfactant blend (e.g., alcohol ethoxylate and arylphenol ethoxylate), and water ad 100%. This mixture is stirred for 1 h to produce spontaneously a thermodynamically stable microemulsion.

### x) Microcapsules (CS)

An oil phase comprising 5-50 wt % of a composition according to the invention, 0-40 wt % water insoluble organic solvent (e.g., aromatic hydrocarbon), 2-15 wt % acrylic monomers (e.g., methylmethacrylate, methacrylic acid and a di- or triacrylate) are dispersed into an aqueous solution of a protective colloid (e.g., polyvinyl alcohol). Radical polymerization initiated by a radical initiator results in the formation of poly (meth) acrylate microcapsules. Alternatively, an oil phase comprising 5-50 wt % of a compound I according to the invention, 0-40 wt % water insoluble organic solvent (e.g. aromatic hydrocarbon), and an isocyanate monomer (e.g., diphenylmethene-4,4′-diisocyanate) are dispersed into an aqueous solution of a protective colloid (e.g., polyvinyl alcohol). The addition of a polyamine (e.g., hexamethylenediamine) results in the formation of polyurea microcapsules. The monomers amount to 1-10 wt %. The wt % relate to the total CS composition.

### xi) Dustable Powders (DP, DS)

1-10 wt % of a composition according to the invention are ground finely and mixed intimately with solid carrier (e.g., finely divided kaolin) ad 100 wt %.

xii) Granules (GR, FG)

0.5-30 wt % of a composition according to the invention is ground finely and associated with solid carrier (e.g., silicate) ad 100 wt %. Granulation is achieved by extrusion, spray-drying or the fluidized bed.

xiii) Ultra-Low Volume Liquids (UL)

1-50 wt % of a composition according to the invention are dissolved in organic solvent (e.g. aromatic hydrocarbon) ad 100 wt %.

The agrochemical compositions types i) to xiii) may optionally comprise further auxiliaries, such as 0.1-1 wt % bactericides, 5-15 wt % anti-freezing agents, 0.1-1 wt % anti-foaming agents, and 0.1-1 wt % colorants.

The agrochemical compositions generally comprise between 0.01 and 95%, preferably between 0.1 and 90%, and in particular between 0.5 and 75%, by weight of active substance. In certain embodiments, the active substances are employed in a purity of from 90% to 100%, preferably from 95% to 100% (according to NMR spectrum).

Solutions for seed treatment (LS), suspoemulsions (SE), flowable concentrates (FS), powders for dry treatment (DS), water-dispersible powders for slurry treatment (WS), water-soluble powders (SS), emulsions (ES), emulsifiable concentrates (EC) and gels (GF) are usually employed for the purposes of treatment of plant propagation materials, particularly seeds. The compositions give, after two-to-tenfold dilution, active substance concentrations of from 0.01 to 60% by weight, preferably from 0.1 to 40% by weight, in the ready-to-use preparations. Application can be carried out before or during sowing.

Methods for applying compositions of the invention on to plant propagation material, especially seeds include dressing, coating, pelleting, dusting, soaking and in-furrow application methods of the propagation material.

Various types of oils, wetters, adjuvants, fertilizer or micronutrients, further pesticides (e.g., herbicides, insecticides, fungicides, growth regulators) or safeners as mentioned above may be added to the compositions.

These agents can be admixed with the compositions according to the invention in a weight ratio of 1:100 to 100:1, preferably 1:10 to 10:1.

The invention also relates to compositions in the form of an agrochemical composition formulated as a 2-component composition comprising a first component comprising a herbicide, a solid or liquid carrier and/or one or more surfactants, and a second component comprising an adjuvant of the subject invention, a solid or liquid carrier and/or one or more surfactants, where additionally both components may also comprise further auxiliaries customary for agrochemical compositions.

### EXAMPLES

A greater understanding of the present invention and of its many advantages may be had from the following examples, given by way of illustration. The following examples are illustrative of some of the methods, applications, embodiments and variants of the present invention. They are, of course, not to be considered as limiting the invention. Numerous changes and modifications can be made with respect to the invention.

### Example 1—Herbicidal Activity Assessment

### Method 1

Compounds were tested on potted plants. Four weed plant seeds were planted and allowed to germinate and establish in 4-inch plastic pots with clear plastic vented domes.
1. Green Foxtail (Setaria viridis), as positive control glyphosate susceptible
2. Palmer Amaranth (Amaranthus palmeri), as test species that is glyphosate resistant

Potted plants were sprayed with 1 mL of 3% of test compound (v/v or w/v) containing a standard surfactant and were also sprayed with 1 mL of Roundup (diluted as indicated). Each pot was covered with clear plastic vented hoods. On day 7 all the hoods were removed, and observations were taken.

Pots were watered twice/week for 15 minutes by bottom watering, allowing water to be slowly absorbed and drawn into the potting soil. Each plant was always watered from its own individual saucer throughout the period of the observation to minimize any cross contamination by material in soil water residues in the plastic saucers.

Observations were made on multiple days including Day 7, Day 10, Day 14 or Day 22 after application.

TABLE 6
Results

| Round Up % | Odorant % | Day 7 | Day 14 |
|---|---|---|---|
| 10% | 3% GDS1 | Heavily Damaged | Both species dead |
| 10% | 3% GDS19 | Heavily Damaged | Both species dead |
| 10% | 3% GDS22 | Heavily Damaged | Both species dead |
| 10% | 3% GDS6 | Bleached | Both species dead |
| 10% | 0% | Damaged | Foxtail dead, |
| | | | Amaranth alive |
| 0% | 3% GDS1 | No damage | Both species alive |
| 0% | 3% GDS19 | No damage | Both species alive |
| 0% | 3% GDS22 | No damage | Both species alive |
| 0% | 3% GDS6 | No damage | Both species alive |

TABLE 7
Results

| Round Up % | Odorant % | Day 7 | Day 10 |
|---|---|---|---|
| 25% | 3% DRG1 | Heavily Damaged | Both species dead |
| 25% | 3% DRG2 | Heavily Damaged | Both species dead |
| 25% | 0% | Damaged | Foxtail dead, |
| | | | Amaranth alive |
| 0% | 3% DRG1 | Minimal damage | Both species alive |
| 0% | 3% DRG2 | Minimal damage | Both species alive |
| Round Up % | Odorant % | Day 7 | Day 22 |
| 25% | 3% NTR15 | Heavily | Dead |
| | | Damaged | |
| 25% | 0% | Bleaching | Foxtail dead, |
| | | Leaves | Amaranth alive |
| 25% | 3% NTR7 | Slight Bleaching | Foxtail dead, only few |
| | | | Amaranth alive |
| 25% | 3% HINT5 | Some effect | Some effect on Amaranth |
| 0% | 3% NTR15 | No damage | Both species alive |
| 0% | 3% NTR7 | No damage | Both species alive |
| 0% | 3% HINT5 | No damage | Both species alive |

### Method 2

To assess the herbicidal effects of test compounds, seeds of test weed plants; Palmer amaranth (Amaranthus palmeri) were sown in plastic pots filled with standard soil recipe. Field plots of Palmer amaranth (Amaranthus palmeri).

Test compounds were dissolved in water to a concentration of 3% (vol/vol). At this concentration none of the tested compounds by themselves, killed the plants. Crop oil concentrate, (Herbicide helper®,) equivalent to 1 fl oz per gallon was added to enhance spray coverage. Solutions were transferred to 40 mL finger spray bottles and pots sprayed till wet, for a total of ~10.5 mL volume per treatment. Solvent controls were treated in the same manner.

The treated pot was hooded in clear plastic for 5 days and kept in controlled conditions of a greenhouse. After 5 days the plastic hoods were removed and the plants exposed and kept open for the reminder of the duration of monitoring at Day 7 and Day 14.

Adjuvant co-application tests were done with Roundup® (Bayer) diluted at 33% strength of the recommended 2%, to a final concentration of 0.66% Roundup.

The plants were monitored and assessed for herbicidal effect or none to either partial or complete damage and or death post application on days 3,7, etc.

TABLE 8
Results

| | | | | Effect on |
|---|---|---|---|---|
| | Compound | Code | Concentration/ | Palmer |
| Rank | Name | Name | Mixture | Amaranth |
| 1 | Gamma- | NTR9 | 3% NTR9 + 33% RU | Death |
| | decalactone | | | |
| 2 | Benzyl | GDS6 | 3% GDS6 + 33% RU | Death |
| | Benzoate | | | |
| 3 | Isoamyl | GDS19 | 3% GDS19 + 33% RU | Severe |
| | Salicylate | | | Damage |
| 4 | Butyl | GDS22 | 3% GDS22 + 33% RU | Severe |
| | Salicylate | | | Damage |
| 5 | Valeric Acid | HGRAS7 | 3% HGRAS7 + | Severe |
| | | | 33% RU | Damage |
| 6 | Round Up | RU | 33% Round Up | No damage/ |
| | | | | very minimal |
| | | | | black spot |

We claim:

1. A composition comprising an adjuvant compound from Table 3 or Table 4, and an agriculturally-active compound.

2. The composition according to claim 1, wherein the agriculturally-active compound is a herbicide.

3. The composition according to claim 2, wherein the herbicide is selected from glyphosate, Atrazine, 2,4-D (2,4-Dichlorophenoxyacetic acid), Dicamba, Glufosinate-Ammonium, Paraquat, sethoxydim, ALS inhibitors, MCPA, flutenacet, ACCase inhibitors, Metolachlor, Imazapyr, Pendimethalin, Trifluralin, and a fatty acid.

4. The composition according to claim 1, wherein the agriculturally-active compound is present in the composition at a concentration that is less than the standard labeled (regulatory approved) concentration needed to achieve the agriculture activity.

5. The composition according to claim 3, wherein the herbicide is glyphosate.

6. The composition according to claim 1, wherein the adjuvant compound is selected from benzyl salicylate, isoamyl salicylate, butyl salicylate, benzyl benzoate, phenethyl butyrate, iso-amyl butyrate, geranyl formate, citronellyl formate, and gamma-cyclodextrin.

7. A method for controlling a weed, wherein said method comprises applying to the weed an adjuvant compound from Table 3 or Table 4, and a herbicide.

8. The method according to claim 7, wherein the herbicide is selected from glyphosate, Atrazine, 2,4-D (2,4-Dichlorophenoxyacetic acid), Dicamba, Glufosinate-Ammonium, Paraquat, Metolachlor, Imazapyr, Pendimethalin, and Trifluralin.

9. The method according to claim 7, wherein the adjuvant compound is selected from benzyl salicylate, isoamyl salicylate, butyl salicylate, benzyl benzoate, phenethyl butyrate, iso-amyl butyrate, geranyl formate, citronellyl formate, and gamma-cyclodextrin.

10. The method according to claim 7, wherein the weed is selected from Poison sumac (Toxicodendron vernix), Japanese knot weed (Polygonum cuspidatum), crabgrass (Digitaria spp.), dandelions (Taraxaum spp.), broadleaf plantain (Plantago major), common ragweed (Ambrosia artemisiifolia), giant ragweed (Abrosia trifida), bindweed (Convolvulus arvensis), ground ivy (Glechoma hederacea), purslane (Portulaca olearacea), stinging nettle (Urtica dioica), curly dock (Rumex crispus), bitter dock (Rumex obtusifolius) wild madder (Galium mollugo), clover leaf (Trifolium), orange jewelweed (Impatiens capensis), bittersweet (Celastrus spp.), horsetail weed (Equisetum arvense), chickweed (Stellaria media), Canada thistle (Cirsium arvense), annual sow thistle (Sonchus oleraceus), quackgrass (Elymus repens), Shepherd's Purse (Capsella bursa-pastoris), woodsorrel (Oxalis stricta), common mallow (Malva neglecta), lambsquarters (Chenopodium album), pigweed (Amaranthus retroflexus), nutsedge (Cyperus spp.), dayflower (Commelina spp.), velvetleaf (Abutilon theophrasti), wild violet (Viola papilionacea), smartweed (Polygonum pensylvanicum), quickweed (Galinsoga parviflora), pokeweed (Phytolacca americana), black nightshade (Solanum nigrum), black medic (Medicago lupulina), poison ivy (Rhus radicans), burdock (Arctium spp.), common groundsel (Senecio vulgaris), curly dock (Rumex crispus), spurge (Euphorbia maculata), puncturevine (Tribulus terrestris), rough cinquefoil (Potentilla norvegica), sandbur (Cenchrus spp.), sheep sorrel (Rumex acetosella), Bermuda grass (Cynodon dactylon), common daisy (Bellis perennis L.), common self-heal (Prunella vulgaris L.), creeping buttercup (Ranunculus repens), doveweed (Murdannia nudiflora), flatweed (Hypochaeris radicata), ground elder (Aegopodium podagraria), herb bennet (Geum urbanum), or marestail (Conyza canadensis).

11. The method according to claim 1, wherein the weed is resistant to a herbicide selected from glyphosate; Atrazine; 2,4-D (2,4-Dichlorophenoxyacetic acid); Dicamba; Glufosinate-Ammonium; Paraquat; Metolachlor; Imazapyr; Pendimethalin; and Trifluralin.

12. The method according to claim 11, wherein the weed is resistant to glyphosate.

13. The method according to claim 7, wherein the herbicide is used at a rate that, when the herbicide is used alone at that rate, it does not control the weed.

14. The method according to claim 7, wherein the weed is in an agriculture field where corn, cotton, wheat, or soybeans are growing, or will be grown.

15. The method according to claim 1, wherein the agriculturally-active compound is a fatty acid or a derivative thereof, or a blend of fatty acids and/or fatty acid derivatives, wherein said fatty acid derivatives are esters, ethers and/or salts of the fatty acid.

16. The composition according to claim 15, wherein the fatty acid is pelargonic acid.

17. A method for:
desiccating a crop prior to harvest;
defoliating a crop prior to harvest;
facilitating harvesting of fruit or nuts; and/or
terminating a cover crop;
wherein said method comprises applying to the crop an adjuvant compound from Table 3, Table 4 or Table 5, and an agriculturally-active compound.

18. The method according to claim 17, used to desiccate a crop prior to harvest.

19. The method according to claim 17, used to defoliate a crop prior to harvest.

20. The method according to claim 17, used to facilitate harvesting of fruit or nuts.

21. The method according to claim 17, used to terminate a cover crop.

22. A method controlling a fungus wherein said method comprises applying to the fungus an adjuvant compound from Table 3, Table 4 or Table 5, and a fungicidally-active compound.
